(19) United States
(12) Patent Application Publication
(10) Pub. No.: US 2006/0203366 A1
(43) Pub. Date: Sep. 14, 2006

(54) Transfer master, transfer holder, transfer apparatus, and magnetic recording medium

(75) Inventor: Akito Kamatani, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/371,905

(22) Filed: Mar. 10, 2006

(30) Foreign Application Priority Data
Mar. 11, 2005 (JP) 069574/2005
Mar. 11, 2005 (JP) 069575/2005
Mar. 11, 2005 (JP) 069576/2005

(51) Int. Cl. G11B 5/86

(52) U.S. Cl. 360/17

(57) ABSTRACT

A transfer holder comprises a pair of support members, which are capable of taking positions close to each other and positions spaced away from each other, the pair of the support members being adapted to support a transfer master, which carries surface information, and a transfer slave material between the pair of the support members. The transfer holder has a constitution such that close contact of the transfer master and the transfer slave material with each other starts from a specific site on the surface of the transfer slave material and successively occurs over the entire area of the surface of the transfer slave material. At least either one of the pair of the support members may be provided with an elastic material on a support surface, which supports the transfer master and the transfer slave material.

### BACKGROUND OF THE INVENTION

1. Field of the Invention

This invention relates to a transfer master, which carries transfer information to be transferred to a transfer slave material. This invention also relates to a transfer holder, which utilizes the transfer master, and a transfer apparatus comprising the transfer holder. This invention further relates to a magnetic recording medium, which is produced with magnetic transfer.

2. Description of the Related Art

There have heretofore been known transfer techniques, such as nano-imprinting techniques and magnetic transfer techniques, for bringing a transfer master, which carries transfer information on its surface, and a transfer slave material into close contact with each other, and transferring the transfer information, which has been carried on the surface of the transfer master, to the transfer slave material. In cases where the transfer techniques are to be performed, it is important that the transfer master and the transfer slave material are accurately brought into close contact with each other.

With conventional transfer techniques, the transfer master and the transfer slave material are supported such that the transfer master and the transfer slave material are parallel with each other as much as possible, and thereafter the transfer master and the transfer slave material are brought into close contact with each other. However, each of the transfer surface of the transfer master and a transfer accepting surface of the transfer slave material has at least slight variations in surface smoothness (due to a production accuracy). Therefore, intra-plane order of occurrence of close contact, in which order the close contact of the transfer surface of the transfer master and the transfer accepting surface of the transfer slave material with each other proceeds from when the close contact is started to when the close contact is finished, is left to take unregulated order. Accordingly, for example, air confinement occurs between the transfer surface of the transfer master and the transfer accepting surface of the transfer slave material in accordance with the intra-plane order of occurrence of close contact. As a result, there is the risk that the transfer master and the transfer slave material will not be capable of being appropriately brought into close contact with each other. In view of the above circumstances, there has been proposed a technique, wherein the transfer master is caused to curve such that the close contact of the transfer surface of the transfer master and the transfer accepting surface of the transfer slave material may start from a protruding site of the transfer surface. The technique, wherein the transfer master is caused to curve, is described in, for example, Japanese Unexamined Patent Publication No. 11(1999)-161956.

However, with the technique described in, for example, Japanese Unexamined Patent Publication No. 11(1999)-161956, wherein the transfer master is caused to curve, it is not always possible to control the curved shape of the transfer master accurately. Therefore, the technique described in, for example, Japanese Unexamined Patent Publication No. 11(1999)-161956, wherein the transfer master is caused to curve, is not practicable. Also, the transfer master having been caused to curve takes on the form such that the transfer master is lifted out of an inside surface of a transfer holder for supporting the transfer master, and the transfer master is not capable of being reliably supported by the transfer holder. Accordingly, the state in which the transfer master has been caused to curve is not capable of being kept even under the condition, in which a low pressure is applied to the transfer holder at the initial stage of the start of the close contact of the transfer master and the transfer slave material with each other. As a result, as in the cases of the flat transfer master, there is the risk that the intra-plane order of occurrence of close contact is not capable of being regulated appropriately.

### SUMMARY OF THE INVENTION

The primary object of the present invention is to provide a transfer master, which is constituted such that intra-plane order of occurrence of close contact of the transfer master and a transfer slave material with each other is capable of being regulated accurately, and such that the transfer master and the transfer slave material are capable of being accurately brought into close contact with each other.

Another object of the present invention is to provide a transfer holder, which is constituted such that intra-plane order of occurrence of close contact of a transfer master and a transfer slave material with each other is capable of being regulated accurately, and such that the transfer master and the transfer slave material are capable of being accurately brought into close contact with each other.

A further object of the present invention is to provide a transfer apparatus comprising the transfer holder.

A still further object of the present invention is to provide a magnetic recording medium, which is produced with magnetic transfer.

The inventors conducted extensive research and found that the aforesaid problems encountered with the conventional techniques are capable of being eliminated in cases where, instead of a transfer master being caused to curve, a transfer master having a thickness distribution is employed. A transfer master, a first transfer holder, a first transfer apparatus, and a first magnetic recording medium in accordance with the present invention are based upon the findings described above.

The present invention provides a transfer master, which has a transfer surface carrying transfer information, the transfer master being adapted for use in a transfer operation for bringing the transfer surface of the transfer master and a transfer slave material into close contact with each other, and thereby transferring the transfer information from the transfer surface of the transfer master to the transfer slave material,

wherein the transfer master has a thickness distribution, such that the close contact of the transfer surface of the transfer master and the transfer slave material with each other starts from a specific site on the transfer surface of the transfer master and successively occurs over the entire area of the transfer surface of the transfer master.

The thickness distribution of the transfer master in accordance with the present invention should preferably be such that a maximum difference in thickness of a region carrying the transfer information falls within the range of 1 μm to 100 μm. Also, the transfer master in accordance with the present invention should preferably be modified such that each of the transfer master and the transfer slave material has a circular disk-like shape, and the thickness distribution of the transfer master is symmetric with respect to a center point of the transfer master or a diametral line of the transfer master. Further, the thickness distribution of the transfer master in accordance with the present invention should preferably be such that the thickness becomes large continuously from an outer periphery side toward the center point side, or such that the thickness becomes large continuously from the center point side toward the outer periphery side.

Furthermore, the transfer master in accordance with the present invention should preferably be modified such that a surface of the transfer master, which surface is opposite to the transfer surface of the transfer master, is a flat surface,

the transfer surface of the transfer master has a surface height distribution corresponding to the thickness distribution of the transfer master, and

a maximum difference in surface height of a region of the transfer surface, which region carries the transfer information, alters such that the maximum difference in surface height at the time of an end of the close contact becomes smaller than the maximum difference in surface height at the time before the close contact starts.

The transfer master in accordance with the present invention may be adapted for magnetic transfer.

The present invention also provides a first transfer holder, comprising a pair of support members, which are capable of taking positions close to each other and positions spaced away from each other, the pair of the support members being adapted to support a transfer master in accordance with the present invention and a transfer slave material between the pair of the support members.

The present invention further provides a first transfer apparatus, comprising a first transfer holder in accordance with the present invention, and pressure applying means for applying a pressure to the transfer holder, the pressure, which is applied by the pressure applying means to the transfer holder, falling within the range of 0.05 MPa to 10.0 MPa.

The present invention still further provides a first magnetic recording medium, which is produced with a magnetic transfer operation for bringing a transfer master in accordance with the present invention and a transfer slave material into close contact with each other, and magnetically transferring the transfer information from the transfer master to a transfer accepting surface of the transfer slave material.

Also, the inventors conducted extensive research and found that the aforesaid problems encountered with the conventional techniques are capable of being eliminated in cases where, instead of a constitution of a transfer master being devised, a constitution of a transfer holder is devised. Second and third transfer holders, second and third transfer apparatuses, and second and third magnetic recording media in accordance with the present invention are based upon the findings described above.

The present invention also provides a second transfer holder, comprising a pair of support members, which are capable of taking positions close to each other and positions spaced away from each other, the pair of the support members being adapted to support a pair of transfer masters, each of which carries surface information, and a transfer slave material between the pair of the support members, such that the surface information carried by one of the transfer masters and the surface information carried by the other transfer master are transferred to opposite surfaces of the transfer slave material, the transfer holder being adapted for use in a transfer operation for locating the pair of the transfer masters and the transfer slave material between the pair of the support members in a state, in which the pair of the support members take the positions spaced away from each other, such that the pair of the transfer masters stand facing the transfer slave material from the opposite surface sides of the transfer slave material, causing the pair of the support members to come close to each other, and thereby bringing each of the pair of the transfer masters and the transfer slave material into close contact with each other under pressure, wherein the transfer holder has a constitution such that the close contact of at least either one of the transfer masters and the transfer slave material with each other starts from a specific site on the corresponding surface of the transfer slave material and successively occurs over the entire area of the corresponding surface of the transfer slave material.

The present invention further provides a third transfer holder, comprising a pair of support members, which are capable of taking positions close to each other and positions spaced away from each other, the pair of the support members being adapted to support a transfer master, which carries surface information, and a transfer slave material between the pair of the support members, such that the surf ace information carried by the transfer master is transferred to one surface of the transfer slave material,

the transfer holder being adapted for use in a transfer operation for locating the transfer master and the transfer slave material between the pair of the support members in a state, in which the pair of the support members take the positions spaced away from each other, such that the transfer master and the one surface of the transfer slave material stand facing each other, causing the pair of the support members to come close to each other, and thereby bringing the transfer master and the transfer slave material into close contact with each other under pressure,

wherein the transfer holder has a constitution such that the close contact of the transfer master and the transfer slave material with each other starts from a specific site on the one surface of the transfer slave material and successively occurs over the entire area of the one surface of the transfer slave material.

The second transfer holder in accordance with the present invention may be modified such that a support surface of at least either one of the pair of the support members, which support surface supports the corresponding transfer master and the transfer slave material, has a surface height distribution such that a site on the support surface corresponding to the specific site on the surface of the transfer slave material, from which specific site the close contact starts, is protruded to a maximum height.

Also, the third transfer holder in accordance with the present invention may be modified such that a support surface of at least either one of the pair of the support members, which support surface supports the transfer master and the transfer slave material, has a surface height distribution such that a site on the support surface corresponding to the specific site on the surface of the transfer slave material, from which specific site the close contact starts, is protruded to a maximum height.

In each of the aforesaid modifications of the second and third transfer holders in accordance with the present invention, the surface height distribution of the support surface should preferably be such that a maximum difference in surface height of a region corresponding to an information transfer accepting region of the transfer slave material falls within the range of 1 μm to 100 μm.

Also, in such cases, each of the second and third transfer holders in accordance with the present invention should preferably be modified such that each of the transfer master and the transfer slave material has a circular disk-like shape, and the support surface has a surface shape, which is symmetric with respect to a center point of the transfer slave material or a diametral line of the transfer slave material. Further, the support surface should preferably has a convex surface shape, such that a surface height becomes large continuously from an outer periphery side toward the center point side, or a concave surface shape, such that the surface height becomes large continuously from the center point side toward the outer periphery side.

Further, in each of the aforesaid modifications of the second and third transfer holders in accordance with the present invention, a maximum difference in surface height of a region of the support surface, which region corresponds to an information transfer accepting region of the transfer slave material, should preferably alter such that the maximum difference in surface height at the time of an end of the close contact becomes smaller than the maximum difference in surface height at the time before the close contact starts.

Furthermore, the second transfer holder in accordance with the present invention may be modified such that at least either one of the pair of the support members is provided with an elastic material, the elastic material being located on a support surface of the at least either one of the pair of the support members, which support surface supports the corresponding transfer master and the transfer slave material, and

the elastic material has a thickness distribution, such that the close contact of the transfer master and the transfer slave material with each other starts from the specific site on the corresponding surface of the transfer slave material and successively occurs over the entire area of the corresponding surface of the transfer slave material.

Also, the third transfer holder in accordance with the present invention may be modified such that at least either one of the pair of the support members is provided with an elastic material, the elastic material being located on a support surface of the at least either one of the pair of the support members, which support surface supports the transfer master and the transfer slave material, and

the elastic material has a thickness distribution, such that the close contact of the transfer master and the transfer slave material with each other starts from the specific site on the corresponding surface of the transfer slave material and successively occurs over the entire area of the corresponding surface of the transfer slave material.

Further, the second transfer holder in accordance with the present invention may be modified such that at least either one of the pair of the support members is provided with an elastic material, which has a plurality of holes containing suction holes, the elastic material being located on a support surface of the at least either one of the pair of the support members, which support surface supports the corresponding transfer master and the transfer slave material, and

the elastic material has the plurality of the holes having been formed with a hole forming density distribution adapted for imparting a thickness distribution to the elastic material in a state, in which the corresponding transfer master has been secured by suction to the at least either one of the pair of the support members with the elastic material intervening between the corresponding transfer master and the at least either one of the pair of the support members,

the thickness distribution being such that the close contact of the transfer master and the transfer slave material with each other starts from the specific site on the corresponding surface of the transfer slave material and successively occurs over the entire area of the corresponding surface of the transfer slave material.

Furthermore, the third transfer holder in accordance with the present invention may be modified such that at least either one of the pair of the support members is provided with an elastic material, which has a plurality of holes containing suction holes, the elastic material being located on a support surface of the at least either one of the pair of the support members, which support surface supports the transfer master and the transfer slave material, and

the elastic material has the plurality of the holes having been formed with a hole forming density distribution adapted for imparting a thickness distribution to the elastic material in a state, in which the transfer master has been secured by suction to the at least either one of the pair of the support members with the elastic material intervening between the transfer master and the at least either one of the pair of the support members,

the thickness distribution being such that the close contact of the transfer master and the transfer slave material with each other starts from the specific site on the corresponding surface of the transfer slave material and successively occurs over the entire area of the corresponding surface of the transfer slave material.

The term “hole forming density” as used herein means the total area of the holes per unit area of the elastic material. The hole forming density distribution is calculated with the unit area being set to be 20% of the close contact area, over which the elastic material and the transfer master come into close contact with each other.

In each of the aforesaid modifications of the second and third transfer holders in accordance with the present invention, wherein the elastic material is located on the support surface, the thickness distribution of the elastic material (or the thickness distribution imparted to the elastic material) should preferably be such that a maximum difference in thickness of a region corresponding to an information transfer accepting region of the transfer slave material falls within the range of 1 μm to 100 μm.

Also, in such cases, each of the second and third transfer holders in accordance with the present invention should preferably be modified such that each of the transfer master and the transfer slave material has a circular disk-like shape, and the thickness distribution of the elastic material (or the thickness distribution imparted to the elastic material) is symmetric with respect to a center point of the transfer slave material or a diametral line of the transfer slave material. Further, the thickness distribution of the elastic material (or the thickness distribution imparted to the elastic material) should preferably be such that the thickness becomes large continuously from an outer periphery side toward the center point side, or such that the thickness becomes large continuously from the center point side toward the outer periphery side.

Each of the second and third transfer holders in accordance with the present invention may be adapted for magnetic transfer.

The present invention still further provides a second transfer apparatus, comprising a second transfer holder in accordance with the present invention, and pressure applying means for applying a pressure to the transfer holder, the pressure, which is applied by the pressure applying means to the transfer holder, falling within the range of 0.05 MPa to 10.0 MPa.

The present invention also provides a third transfer apparatus, comprising a third transfer holder in accordance with the present invention, and pressure applying means for applying a pressure to the transfer holder, the pressure, which is applied by the pressure applying means to the transfer holder, falling within the range of 0.05 MPa to 10.0 MPa.

The present invention further provides a second magnetic recording medium, which is produced with a magnetic transfer operation performed by use of a second transfer holder in accordance with the present invention.

The present invention still further provides a third magnetic recording medium, which is produced with a magnetic transfer operation performed by use of a third transfer holder in accordance with the present invention.

The transfer master in accordance with the present invention has the thickness distribution described above, instead of being caused to curve. Therefore, with the transfer master in accordance with the present invention, by virtue of the thickness distribution of the transfer master, the close contact of the transfer surface of the transfer master and the transfer slave material with each other is capable of starting from the specific site on the transfer surface of the transfer master and successively occurring over the entire area of the transfer surface of the transfer master.

With each of the transfer holders in accordance with the present invention, the constitution of the transfer holder is devised in the specific ways, the transfer holder comprising the pair of the support members, which are capable of taking the positions close to each other and the positions spaced away from each other, the pair of the support members being adapted to support the transfer master and the transfer slave material between the pair of the support members. Therefore, with each of the transfer holders in accordance with the present invention, the close contact of the transfer master (or the at least either one of the transfer masters in the cases of the transfer to the opposite surfaces of the transfer slave material) and the transfer slave material with each other is capable of starting from the specific site on the surface of the transfer slave material and successively occurring over the entire area of the surface of the transfer slave material.

With each of the transfer master, the transfer holders, and the transfer apparatuses in accordance with the present invention, the intra-plane order of the occurrence of the close contact of the transfer master and the transfer slave material with each other is capable of being regulated accurately. Therefore, it is possible to prevent the problems from occurring with regard to air confinement between the transfer surface of the transfer master and the transfer accepting surface of the transfer slave material, and the like. Accordingly, the transfer master and the transfer slave material are capable of being accurately brought into close contact with each other.

Also, each of the transfer master, the transfer holders, and the transfer apparatuses in accordance with the present invention has the advantages over the conventional techniques, wherein the transfer master is caused to curve, in that accurate processing for obtaining the structure for regulating the intra-plane order of the occurrence of the close contact is capable of being performed easily. Further, each of the transfer master, the transfer holders, and the transfer apparatuses in accordance with the present invention has the advantages over the conventional techniques in that the structure for regulating the intra-plane order of the occurrence of the close contact is capable of being kept accurately even under the condition, in which a low pressure is applied to the transfer holder at the initial stage of the start of the close contact of the transfer master and the transfer slave material with each other. Therefore, the accurate close contact of the transfer master and the transfer slave material with each other is capable of being obtained reliably.

### BRIEF DESCRIPTION OF THE DRAWINGS

FIG. 1A is a side view showing a first embodiment of the transfer apparatus in accordance with the present invention in a state in which a pair of support members take positions most spaced away from each other,

FIG. 1B is a side view showing the first embodiment of the transfer apparatus in accordance with the present invention in a state in which the pair of the support members take positions closest to each other,

FIG. 2A is a side view showing a modification of the first embodiment of the transfer apparatus in accordance with the present invention in a state in which a pair of support members take positions most spaced away from each other,

FIG. 2B is a side view showing the modification of the first embodiment of the transfer apparatus in accordance with the present invention in a state in which the pair of the support members take positions closest to each other,

FIG. 3 is a plan view showing a transfer master,

FIG. 4A is a sectional view showing a transfer slave material in a state in which magnetic recording layers of the transfer slave material are subjected to initial magnetization,

FIG. 4B is a sectional view showing how magnetic transfer from the transfer master to the transfer slave material is performed,

FIGS. 5A and 5B are side views showing modifications of the first embodiment of the transfer apparatus in accordance with the present invention,

FIGS. 6A and 6B are side views showing modifications of the first embodiment of the transfer apparatus in accordance with the present invention,

FIG. 7A is a perspective view showing a subcylindrical transfer surface of a transfer master,

FIG. 7B is an explanatory view containing a plan view showing the transfer master having the subcylindrical transfer surface shown in FIG. 7A and a support member, which plan view is taken from the transfer surface side of the transfer master, and two side views showing the transfer master and the support member, which side views are taken from directions varying by an angle of 90° from each other,

FIG. 8A is a perspective view showing a saddle surface-shaped transfer surface of a transfer master,

FIG. 8B is an explanatory view containing a plan view showing the transfer master having the saddle surface-shaped transfer surface shown in FIG. 8A and a support member, which plan view is taken from the transfer surface side of the transfer master, and two side views showing the transfer master and the support member, which side views are taken from directions varying by an angle of 90° from each other,

FIG. 9A is a side view showing a second embodiment of the transfer apparatus in accordance with the present invention in a state in which a pair of support members take positions most spaced away from each other,

FIG. 9B is a side view showing the second embodiment of the transfer apparatus in accordance with the present invention in a state in which the pair of the support members take positions closest to each other,

FIG. 9C is a side view showing a modification of the second embodiment of the transfer apparatus in accordance with the present invention in a state in which a pair of support members take positions most spaced away from each other,

FIGS. 10A and 10B are side views showing modifications of the second embodiment of the transfer apparatus in accordance with the present invention,

FIGS. 11A and 11B are side views showing modifications of the second embodiment of the transfer apparatus in accordance with the present invention,

FIG. 12A is a perspective view showing a subcylindrical support surface of a support member,

FIG. 12B is an explanatory view containing a plan view showing a transfer master and the support member having the subcylindrical support surface shown in FIG. 12A, which plan view is taken from a transfer surface side of the transfer master, and two side views showing the transfer master and the support member, which side views are taken from directions varying by an angle of 90° from each other,

FIG. 13A is a perspective view showing a saddle surface-shaped support surface of a support member,

FIG. 13B is an explanatory view containing a plan view showing a transfer master and the support member having the saddle surface-shaped support surface shown in FIG. 13A, which plan view is taken from a transfer surface side of the transfer master, and two side views showing the transfer master and the support member, which side views are taken from directions varying by an angle of 90° from each other,

FIG. 14A is a side view showing a third embodiment of the transfer apparatus in accordance with the present invention in a state in which a pair of support members take positions most spaced away from each other,

FIG. 14B is a side view showing the third embodiment of the transfer apparatus in accordance with the present invention in a state in which the pair of the support members take positions closest to each other,

FIGS. 15A and 15B are side views showing modifications of the third embodiment of the transfer apparatus in accordance with the present invention,

FIGS. 16A and 16B are side views showing modifications of the third embodiment of the transfer apparatus in accordance with the present invention,

FIG. 17A is a perspective view showing a subcylindrical support surface of an elastic material,

FIG. 17B is an explanatory view containing a plan view showing a transfer master and a support member, which plan view is taken from a transfer surface side of the transfer master, and two side views showing the transfer master, the elastic material having the subcylindrical support surface shown in FIG. 17A, and the support member, which side views are taken from directions varying by an angle of 90° from each other,

FIG. 18A is a perspective view showing a saddle surface-shaped support surface of an elastic material, and

FIG. 18B is an explanatory view containing a plan view showing a transfer master and a support member, which plan view is taken from a transfer surface side of the transfer master, and two side views showing the transfer master, the elastic material having the saddle surface-shaped support surface shown in FIG. 18A, and the support member, which side views are taken from directions varying by an angle of 90° from each other,

### DESCRIPTION OF THE PREFERRED EMBODIMENTS

The present invention will hereinbelow be described in further detail with reference to the accompanying drawings.

### First embodiment

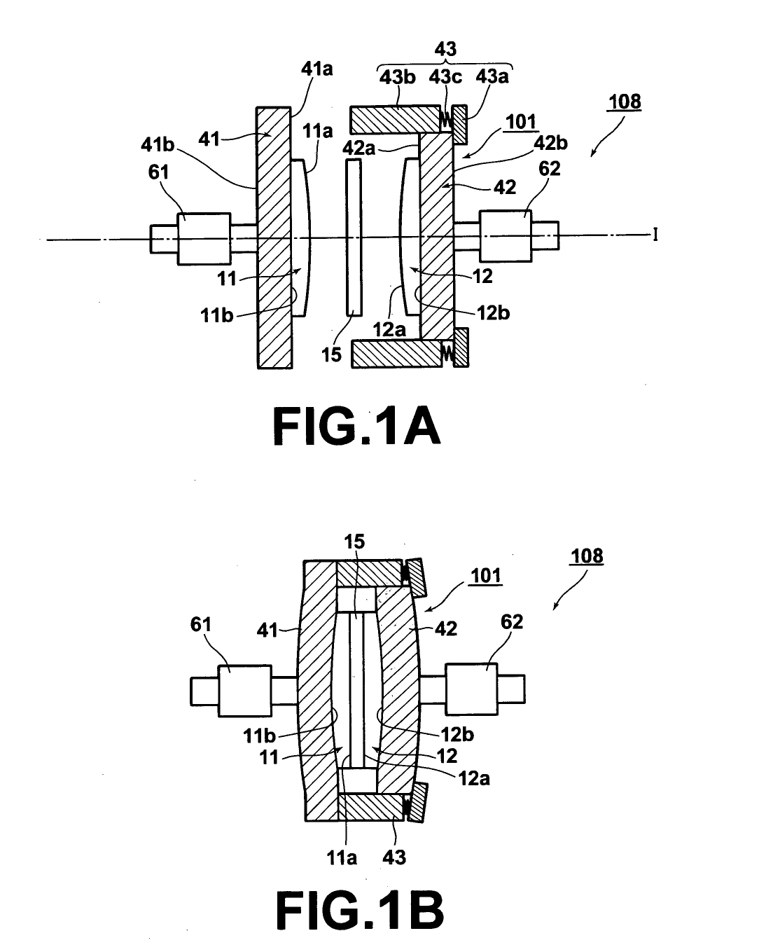

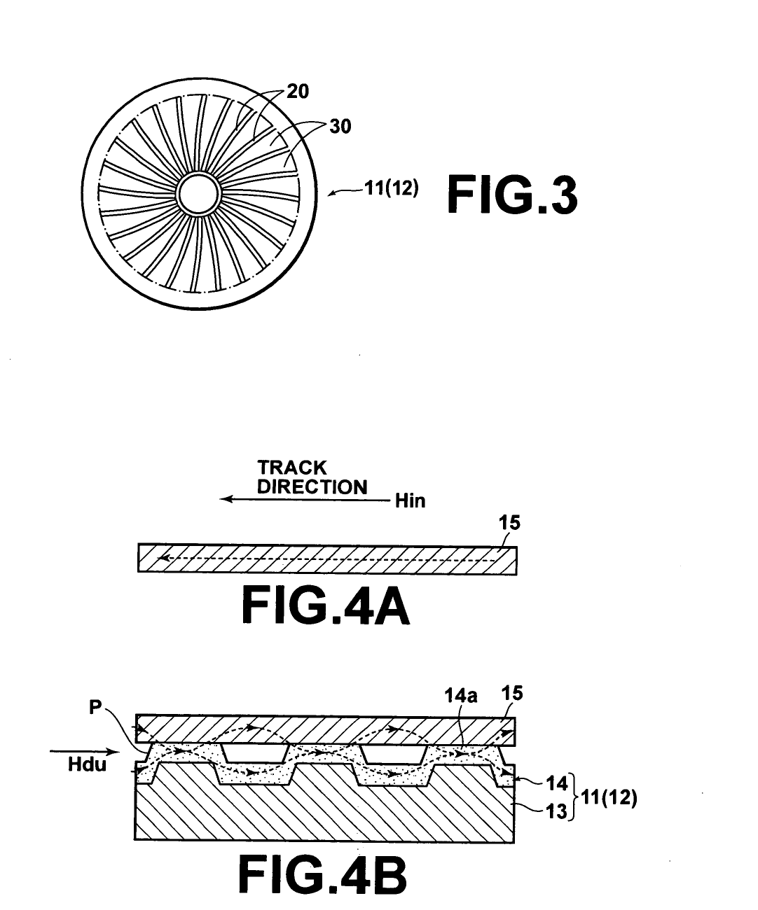

A first embodiment of the transfer apparatus in accordance with the present invention will be described hereinbelow by taking magnetic transfer to opposite surfaces of a transfer slave material as an example. FIG. 1A is a side view showing a first embodiment of the transfer apparatus in accordance with the present invention in a state in which a pair of support members take positions most spaced away from each other. FIG. 1B is a side view showing the first embodiment of the transfer apparatus in accordance with the present invention in a state in which the pair of the support members take positions closest to each other. In FIGS. 1A and 1B, a transfer holder is illustrated as a sectional view. FIG. 3 is a plan view showing a transfer master. FIG. 4A is a thickness sectional view taken in a track direction and showing a transfer slave material in a state in which magnetic recording layers of the transfer slave material are subjected to initial magnetization. FIG. 4B is a thickness sectional view taken in the track direction and showing a transfer master and the transfer slave material, the view serving as an aid in explaining how magnetic transfer from the transfer master to the transfer slave material is performed.

With reference to FIGS. 1A and 1B, in this embodiment of a transfer apparatus 108, surface information carried by a transfer master 11 is transferred to one of the opposite surfaces of a transfer slave material 15, and surface information carried by a transfer master 12 is transferred to the other surface of the transfer slave material 15.

As illustrated in FIG. 3, each of the transfer master 11 and the transfer master 12 has a circular disk-like shape, as viewed from above, and has an aperture at its center region. Each of the transfer master 11 and the transfer master 12 has a plurality of signal transferable regions 20, 20, . . . , each of which carries a fine surface recess-protrusion pattern (i.e., surface information) P corresponding to a signal pattern to be transferred to the transfer slave material 15. Each of the transfer master 11 and the transfer master 12 also has a plurality of non-transferable regions 30, 30, . . . , each of which is located between adjacent signal transferable regions 20, 20 and does not carry the fine surface recess-protrusion pattern P. (The fine surface recess-protrusion pattern P will be described later with reference to FIG. 4B.) The plurality of the signal transferable regions 20, 20, . . . extend radially from the center point side, such that each of the non-transferable regions 30, 30, . . . having an approximately fan-like shape is formed between the adjacent signal transferable regions 20, 20. Specifically, each of the transfer master 11 and the transfer master 12 has the signal transferable regions 20, 20, . . . and the non-transferable regions 30, 30, . . . , which are located alternately, as viewed in the track direction.

As illustrated in the sectional view of FIG. 4B, each of the signal transferable regions 20, 20, . . . of the transfer master 11 (or 12) is constituted of a transfer master base plate (i.e., a master base plate) 13 and a magnetic layer 14, which is overlaid on the transfer master base plate 13. The transfer master base plate 13 is made from a metal and has a surface recess-protrusion pattern, which is approximately identical with the surface recess-protrusion pattern P corresponding to the signal pattern to be transferred to the transfer slave material 15. The magnetic layer 14 is overlaid on the transfer master base plate 13 along the surface shape of the transfer master base plate 13 and has the surface recess-protrusion pattern P.

As the transfer slave material 15, a circular disk-shaped slave medium is utilized. The slave medium is provided with magnetic recording layers (not shown) formed on the opposite surfaces of the slave medium and has an aperture at the center region.

As illustrated in FIG. 4A, a magnetic field Hᵢₙ is applied previously to the transfer slave material 15 along the track direction or along the thickness direction, and the magnetic recording layers (not shown) of the transfer slave material 15 are thus subjected to initial magnetization. (FIG. 4A shows the cases where the magnetic field Hᵢₙ is applied along the track direction.) The transfer slave material 15, which has thus been subjected to the initial magnetization, is located so as to stand facing the surface of the transfer master 11 (or 12) and is then brought into close contact with the surface of the transfer master 11 (or 12).

Thereafter, as illustrated in FIG. 4B, a transfer magnetic field H_{du} is applied to the transfer master 11 (or 12) and the transfer slave material 15, which have been brought into close contact with each other, in a direction approximately reverse to the direction of the initial magnetization. At this time, the transfer magnetic field H_{du} is attracted approximately selectively into protruding areas 14a, 14a, . . . alone of the magnetic layer 14 of the transfer master 11 (or 12), which protruding areas 14a, 14a, . . . are in close contact with the transfer slave material 15. As a result, in the cases of intra-plane recording, the direction of the initial magnetization is not inverted in the areas of the magnetic recording layer of the transfer slave material 15, which areas are in close contact with the protruding areas 14a, 14a, and the direction of the initial magnetization is inverted in the other areas of the magnetic recording layer of the transfer slave material 15. In the cases of normal recording, the direction of the initial magnetization is inverted in the areas of the magnetic recording layer of the transfer slave material 15, which areas are in close contact with the protruding areas 14a, 14a, . . . , and the direction of the initial magnetization is not inverted in the other areas of the magnetic recording layer of the transfer slave material 15. In the manner described above, the magnetization pattern corresponding to the surface recess-protrusion pattern P of the transfer master 11 (or 12) is magnetically transferred to the transfer slave material 15, and a magnetic recording medium is produced.

Reverting to FIGS. 1A and 1B, in this embodiment of the transfer apparatus 108, a transfer holder 101 comprises a pair of support members 41 and 42, which are capable of taking positions close to each other and positions spaced away from each other. The pair of the support members 41 and 42 are adapted to support the pair of the transfer masters 11 and 12 and the transfer slave material 15 between the pair of the support members 41 and 42. An inside surface of the support member 41 acts as a support surface 41a for supporting the transfer masters 11 and 12 and the transfer slave material 15. Also, an inside surface of the support member 42 acts as a support surface 42a for supporting the transfer masters 11 and 12 and the transfer slave material 15. Each of the support member 41 and the support member 42 has a plurality of suction holes (not shown) connected to suction means, such as a pressure reducing pump. The transfer master 11 is secured by suction to the support surface 41a of the support member 41. Also, the transfer master 12 is secured by suction to the support surface 42a of the support member 42. The shapes of the suction holes may be selected from various shapes, such as cylindrical shapes and groove-like shapes.

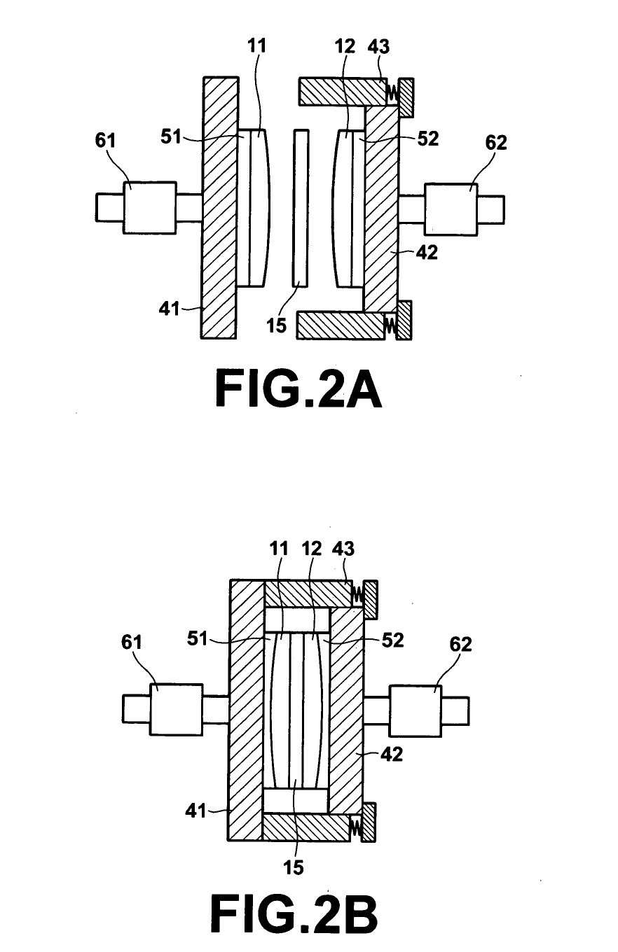

FIG. 2A is a side view showing a modification of the first embodiment of the transfer apparatus in accordance with the present invention in a state in which a pair of support members take positions most spaced away from each other. FIG. 2B is a side view showing the modification of the first embodiment of the transfer apparatus in accordance with the present invention in a state in which the pair of the support members take positions closest to each other. In FIGS. 2A and 2B, similar elements are numbered with the same reference numerals with respect to FIG. 1A. As illustrated in FIG. 2A, the constitution described above should preferably be modified such that an elastic material 51 having a plurality of suction holes (not shown) is secured to the support surface 41a of the support member 41, and an elastic material 52 having a plurality of suction holes (not shown) is secured to the support surface 42a of the support member 42. In this modification, the transfer master 11 is secured by suction via the elastic material 51 to the support member 41, and the transfer master 12 is secured by suction via the elastic material 52 to the support member 42. With the modification provided with the elastic materials 51 and 52, it becomes possible to compensate for fine variations of the thicknesses of the transfer masters 11 and 12 and the transfer slave material 15 and fine variations of the shapes of the support surfaces 41a and 42a of the support members 41 and 42. Therefore, the transfer masters 11 and 12 are capable of being accurately brought into close contact with the transfer slave material 15. The utilization of the elastic materials 51 and 52 is efficient particularly in cases where the area of the transfer slave material 15 is large. The effect described above is capable of being obtained with the constitution, in which the elastic material is located on the support surface of at least either one of the support members 41 and 42.

Each of the support members 41 and 42 has an approximately circular disk-like shape corresponding to the shape of each of the transfer masters 11 and 12 and the transfer slave material 15. A peripheral wall 43, which constitutes a peripheral surface of the transfer holder 101, is fitted to the support member 42 along the peripheral surface of the support member 42. The peripheral wall 43 has an approximately L-shaped cross-section. Specifically, the peripheral wall 43 is bent from the side of an opposite surface 42b of the support member 42, which surface is opposite to the support surface 42a of the support member 42, toward the peripheral surface side of the support member 42. The peripheral wall 43 is constituted of a plate-shaped member 43a, which is parallel with the opposite surface 42b of the support member 42, a plate-shaped member 43b, which is parallel with the peripheral surface of the support member 42, and a spring member 43c, which is set between the plate-shaped member 43a and the plate-shaped member 43b. The plate-shaped member 43b is capable of being slid with respect to the support member 42 by expansion and contraction of the spring member 43c.

The transfer holder 101 is adapted for use in a transfer operation described below. Specifically, firstly, as illustrated in FIG. 1A, the pair of the support members 41 and 42 are located at the positions spaced away from each other, and the transfer slave material 15 is supplied to the position between the transfer master 11, which has been secured to the support member 41, and the transfer master 12, which has been secured to the support member 42. Each of the pair of the transfer masters 11 and 12 and the transfer slave material 15 are thus located so as to stand facing each other. Thereafter, as illustrated in FIG. 1B, the pair of the support members 41 and 42 are caused to come close to each other. The transfer master 11, the transfer slave material 15, and the transfer master 12 are thus brought into close contact with one another under pressure. As described above, the spring member 43c capable of undergoing expansion and contraction is set in the peripheral wall 43. Therefore, at the time at which the close contact of each of the transfer masters 11 and 12 and the transfer slave material 15 with each other is completed, the support member 41 and the peripheral wall 43 come into close contact with each other regardless of the thicknesses of the transfer masters 11 and 12 and the transfer slave material 15, and the region within the transfer holder 101 is sealed.

This embodiment of the transfer apparatus 108 comprises the transfer holder 101 and other apparatus members necessary for the magnetic transfer. By way of example, the transfer apparatus 108 also comprises a transfer slave material accommodating section for accommodating the transfer slave material 15. The transfer apparatus 108 further comprises conveying means, such as a robot arm, for conveying the transfer slave material 15 from the transfer slave material accommodating section into the region within the transfer holder 101. The transfer apparatus 108 still further comprises support member moving means for moving at least either one of the pair of the support members 41 and 42 of the transfer holder 101 with respect to the other, such that the pair of the support members 41 and 42 take the positions close to each other and the positions spaced away from each other. The transfer apparatus 108 also comprises magnetic field applying means for applying the magnetic field to the transfer masters 11 and 12 and the transfer slave material 15, which have been supported by the transfer holder 101, from the outside of the transfer holder 101.

In FIGS. 1A and 1B, as the constituent members of the transfer apparatus 108 other than the transfer holder 101, pushing members (i.e., pressure applying means) 61 and 62 alone are illustrated. The pushing members 61 and 62 are the constituent members of the support member moving means. The pushing member 61 is secured to an opposite surface 41b of the support member 41, which surface is opposite to the support surface 41a of the support member 41. The pushing member 62 is secured to the opposite surface 42b of the support member 42, which surface is opposite to the support surface 42a of the support member 42. The pushing members 61 and 62 support the support members 41 and 42, respectively, and push the pair of the support members 41 and 42 in the directions that cause the pair of the support members 41 and 42 to come close to each other.

How each of the transfer masters 11 and 12 in this embodiment is constituted and how each of the transfer masters 11 and 12 and the transfer slave material 15 are brought into close contact with each other will be described hereinbelow.

In this embodiment, each of the transfer masters 11 and 12 has a thickness distribution, such that the thickness of the transfer master becomes large continuously from the outer periphery side toward the center point side, the center point side having the largest thickness. Each of the support surface 41a of the support member 41 and the support surface 42a of the support member 42 is flat. Therefore, when the transfer master 11, which is softer than the support member 41, has been secured by suction to the support member 41, an opposite surface 11b of the transfer master 11, which surface is opposite to a transfer surface 11a of the transfer master 11 and stands facing the side of the support member 41, becomes flat, and the transfer surface 11a of the transfer master 11 takes the surface shape corresponding to the thickness distribution of the transfer master 11. Also, when the transfer master 12, which is softer than the support member 42, has been secured by suction to the support member 42, an opposite surface 12b of the transfer master 12, which surface is opposite to a transfer surface 12a of the transfer master 12 and stands facing the side of the support member 42, becomes flat, and the transfer surface 12a of the transfer master 12 takes the surface shape corresponding to the thickness distribution of the transfer master 12. In this embodiment, each of the transfer surface 11a of the transfer master 11 and the transfer surface 12a of the transfer master 12 has a subspherical convex surface shape, which is symmetric with respect to the center point of the transfer master. Each of the transfer surface 11a of the transfer master 11 and the transfer surface 12a of the transfer master 12 has a surface height distribution, such that the surface height becomes large continuously from the outer periphery side toward the center point side, and such that the center point side is protruded to a maximum height. In FIG. 1A, a center axis line is represented by a reference numeral I.

A maximum difference in thickness of each of the signal transferable regions 20, 20, . . . (i.e., the regions carrying the transfer information) of each of the transfer masters 11 and 12 should preferably fall within the range of 1 μm to 100 μm, and should more preferably fall within the range of 5 μm to 100 μm. Each of the transfer masters 11 and 12 having the fine thickness distribution described above is capable of being formed accurately with processing, such as grinding, cutting, etching, or photolithography. Also, each of the transfer masters 11 and 12 having the fine thickness distribution described above is capable of being formed accurately with processing, wherein electro forming is performed by use of a mold having been formed with grinding, cutting, etching, or photolithography.

When necessary, the one surface or the opposite surfaces of each of the transfer masters 11 and 12 may be subjected to surface processing. For example, for reduction of frictional force, or the like, each of the transfer masters 11 and 12 may be subjected to surface roughing processing, such as blasting.

Such that the magnetic field may be applied accurately from the exterior of the transfer holder 101 to the transfer masters 11 and 12 and the transfer slave material 15, which have been supported within the transfer holder 101, the thickness of each of the regions of each of the support members 41 and 42, which regions correspond to the signal transferable regions 20, 20, . . . , is ordinarily set at a value on the order of millimeter, and should preferably be at most 10 mm. With respect to the thickness of each of the support members 41 and 42, which thickness is on the order of millimeter, the thickness distribution of each of the transfer masters 11 and 12 is as narrow as the order of micron. In FIG. 1A, for clearness, the thickness distribution of each of the transfer masters 11 and 12 is illustrated to be wider than the actual thickness distribution.

In this embodiment, the close contact with the transfer slave material 15 starts from the inner periphery site on each of the transfer masters 11 and 12, which site is protruded to the maximum height. Specifically, the close contact of the transfer master 11 and the transfer slave material 15 with each other starts from the inner periphery site on the transfer surface 11a and successively occurs toward the outer periphery site and over the entire area of the transfer surface 11a. Also, the close contact of the transfer slave material 15 and the transfer master 12 with each other starts from the inner periphery site on the transfer surface 12a and successively occurs toward the outer periphery site and over the entire area of the transfer surface 12a.

In this embodiment, as illustrated in FIG. 1B or FIG. 2B, the material of each of the transfer surface 11a and the transfer surface 12a, or the like, is designed such that the maximum difference in surface height of each of the signal transferable regions 20, 20, . . . of each of the transfer surface 11a and the transfer surface 12a at the time of the end of the close contact under pressure becomes smaller than the maximum difference in surface height at the time before the close contact starts, and such that each of the transfer surface 11a and the transfer surface 12a at the time of the end of the close contact takes on the form of a flat surface or a surface shape close to the flat surface. In such cases, at the time of the end of the close contact, each of the opposite surface 11b of the transfer master 11, which surface is opposite to the transfer surface 11a of the transfer master 11, and the opposite surface 12b of the transfer master 12, which surface is opposite to the transfer surface 12a of the transfer master 12, is pushed out to the outward side and takes on the form of, for example, the convex surface shape as illustrated in FIG. 1B or FIG. 2B. As each of the opposite surface 11b of the transfer master 11, which surface is opposite to the transfer surface 11a of the transfer master 11, and the opposite surface 12b of the transfer master 12, which surface is opposite to the transfer surface 12a of the transfer master 12, is thus pushed out to the outward side, each of the support members 41 and 42 or each of the elastic materials 51 and 52 is deformed. Due to the close contact under pressure, the difference in surface height of each of the transfer surface 11a and the transfer surface 12a becomes smaller than the difference in surface height at the time before the close contact starts, and each of the transfer surface 11a and the transfer surface 12a takes on the form of the flat surface or the surface shape close to the flat surface. Therefore, the close contact of each of the transfer masters 11 and 12 and the transfer slave material 15 with each other is capable of occurring accurately over the entire area of each of the transfer surface 11a and the transfer surface 12a.

The inventors have found that, in cases where the maximum difference in thickness of each of the signal transferable regions 20, 20, . . . of each of the transfer masters 11 and 12 is set to be at least 1 μm, preferably at least 5 μm, the intra-plane order of the occurrence of the close contact is capable of being regulated accurately in the manner described above. Also, the inventors have found that, in cases where the maximum difference in thickness of each of the signal transferable regions 20, 20, . . . of each of the transfer masters 11 and 12 is at most 100 μm, the problems are capable of being prevented from occurring in that the transfer master 11 or 12 becomes lifted out of the corresponding support member 41 or 42 (or the corresponding elastic material 51 or 52). The inventors have thus found that, in such cases, the entire area of each of the opposite surface 11b of the transfer master 11 and the opposite surface 12b of the transfer master 12 is capable of being accurately kept in close contact with the corresponding support member 41 or 42 (or the corresponding elastic material 51 or 52), and the transfer masters 11 and 12 are capable of being reliably supported in the transfer holder 101. Further, the inventors have found that, in cases where the maximum difference in thickness of each of the signal transferable regions 20, 20, . . . of each of the transfer masters 11 and 12 is at most 100 μm, damages of the transfer masters 11 and 12 due to curving are capable of being suppressed.

In this embodiment, the pressure, which is applied by the pushing members 61 and 62 (i.e., the pressure applying means) to the transfer holder 101, should preferably fall within the range of 0.05 MPa to 10.0 MPa. In the cases of the magnetic transfer, the pressure, which is applied by the pushing members 61 and 62 (i.e., the pressure applying means) to the transfer holder 101, should more preferably fall within the range of 0.05 MPa to 1.0 MPa. If the applied pressure is markedly low, there will be the risk that the close contact of each of the transfer masters 11 and 12 and the transfer slave material 15 with each other will become insufficient. If the applied pressure is markedly high, there will be the risk that the speed, with which the close contact of each of the transfer masters 11 and 12 and the transfer slave material 15 with each other occurs, will become markedly high, and the intra-plane order of the occurrence of the close contact will not be capable of being regulated accurately in the manner described above.

In this embodiment, the transfer masters 11 and 12, the transfer holder 101, and the transfer apparatus 108 are constituted in the manner described above.

With this embodiment, each of the transfer masters 11 and 12 has the thickness distribution described above, instead of being caused to curve. Therefore, by virtue of the thickness distribution of the transfer master 11, the close contact of the transfer surface 11a of the transfer master 11 and the transfer slave material 15 with each other is capable of starting from the specific site on the transfer surface 11a of the transfer master 11 and successively occurring over the entire area of the transfer surface 11a of the transfer master 11. Also, by virtue of the thickness distribution of the transfer master 12, the close contact of the transfer surface 12a of the transfer master 12 and the transfer slave material 15 with each other is capable of starting from the specific site on the transfer surface 12a of the transfer master 12 and successively occurring over the entire area of the transfer surface 12a of the transfer master 12. Further, with this embodiment, the intra-plane order of the occurrence of the close contact of each of the transfer masters 11 and 12 and the transfer slave material 15 with each other is capable of being regulated accurately. Therefore, it is possible to prevent the problems from occurring with regard to air confinement between the transfer surface 11a or 12a and the transfer accepting surface of the transfer slave material 15, and the like. Accordingly, each of the transfer masters 11 and 12 and the transfer slave material 15 are capable of being accurately brought into close contact with each other.

Furthermore, with the embodiment described above, the thickness distribution of the transfer master 11 is symmetric with respect to the center point of the transfer master 11 (i.e., rotationally symmetric with respect to the center axis line I). Also, the thickness distribution of the transfer master 12 is symmetric with respect to the center point of the transfer master 12 (i.e., rotationally symmetric with respect to the center axis line I). Therefore, the close contact of each of the transfer masters 11 and 12 and the transfer slave material 15 is capable of proceeding reliably from the inner periphery site on each of the transfer surface 11a and the transfer surface 12a and successively occurring toward the outer periphery site. The close contact is thus capable of proceeding uniformly with respect to the peripheral direction of each of the transfer surface 11a and the transfer surface 12a, and the intra-plane order of the occurrence of the close contact is capable of being regulated accurately.

Also, the embodiment described above has the advantages over the conventional techniques, wherein the transfer master is caused to curve, in that the accurate processing of each of the transfer masters 11 and 12 for obtaining the structure for regulating the intra-plane order of the occurrence of the close contact is capable of being performed easily and at a low cost. As described above, each of the transfer masters 11 and 12 is capable of being formed accurately with the processing, such as grinding, cutting, etching, or photolithography. Further, each of the transfer masters 11 and 12 is capable of being formed accurately with processing, wherein electro forming is performed by use of a mold having been formed with grinding, cutting, etching, or photolithography. Furthermore, the embodiment described above has the advantages over the conventional techniques in that there is no risk of the transfer master 11 or 12 becoming lifted out of the corresponding support member 41 or 42 (or the corresponding elastic material 51 or 52). Therefore, the entire area of each of the opposite surface 11b of the transfer master 11 and the opposite surface 12b of the transfer master 12 is capable of being accurately kept in close contact with the corresponding support member 41 or 42 (or the corresponding elastic material 51 or 52), and the transfer masters 11 and 12 are capable of being reliably supported in the transfer holder 101. Accordingly, the shape of each of the transfer masters 11 and 12 for regulating the intra-plane order of the occurrence of the close contact is capable of being kept accurately even under the condition, in which a low pressure is applied to the transfer holder 101 at the initial stage of the start of the close contact of each of the transfer masters 11 and 12 and the transfer slave material 15 with each other. The accurate close contact of each of the transfer masters 11 and 12 and the transfer slave material 15 with each other is thus capable of being obtained reliably.

In the embodiment described above, in cases where the transfer slave material 15 is to be taken out of the transfer holder 101 after the application of the transfer magnetic field H_{du} has been finished, the pressure applied to the transfer holder 101 is released. At this time, restoring force for the restoration to the original shape occurs with each of the transfer masters 11 and 12. The restoring force acts as the force for separating the transfer slave material 15 from each of the transfer surface 11a of the transfer master 11 and the transfer surface 12a of the transfer master 12. Therefore, the transfer slave material 15 is capable of being separated easily from each of the transfer surface 11a of the transfer master 11 and the transfer surface 12a of the transfer master 12 and is capable of being taken out easily from the transfer holder 101.

In the embodiment described above, wherein the transfer holder 101 and the transfer apparatus 108 utilize the transfer masters 11 and 12, accurate magnetic transfer is capable of being performed. In cases where the transfer holder 101 and the transfer apparatus 108 in this embodiment are utilized, a magnetic recording medium having been subjected to the accurate magnetic transfer is capable of being produced reliably.

### Modifications of the First Embodiment

The first embodiment described above may be modified in various ways.

Specifically, each of the transfer masters 11 and 12 may be replaced by a transfer master, which has the thickness distribution such that the close contact of the transfer master and the transfer slave material 15 with each other starts from the specific site on the transfer surface of the transfer master and successively occurs over the entire area of the transfer surface of the transfer master. In such cases, the same effects as those with the embodiment described above are capable of being obtained.

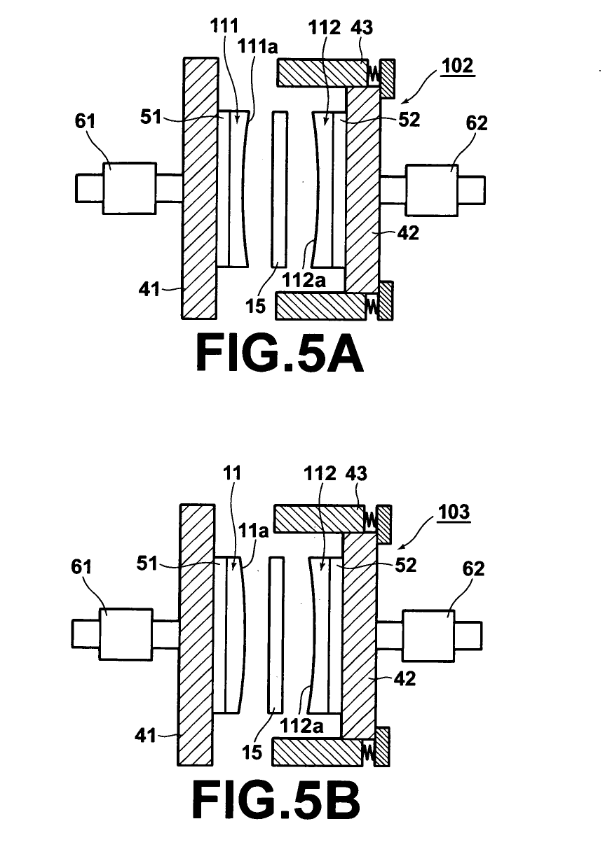

For example, FIG. 5A shows a modification, in which a transfer master 111 and a transfer master 112 are supported within a transfer holder 102. In FIG. 5A (and FIG. 5B to FIG. 8B that follow), similar elements are numbered with the same reference numerals with respect to FIG. 1A and FIG. 2A. In this modification, each of the transfer masters 111 and 112 has a thickness distribution, such that the thickness of the transfer master becomes large continuously from the center point side toward the outer periphery side, the outer periphery side being protruded to a maximum height. Also, each of a transfer surface 111a of the transfer master 111 and a transfer surface 112a of the transfer master 112 has a subspherical concave surface shape, which is symmetric with respect to the center point of the transfer slave material 15. With the constitution shown in FIG. 5A, the close contact of each of the transfer masters 111 and 112 and the transfer slave material 15 with each other starts from the outer periphery site on each of the transfer surfaces 111a and 112a and successively occurs toward the inner periphery site and over the entire area of each of the transfer surfaces 111a and 112a.

FIG. 5B shows a modification, in which the transfer master 11 and the transfer master 112 having different thickness distributions are supported within a transfer holder 103. In the modification shown in FIG. 5B, the transfer master 11 has the thickness distribution illustrated in FIG. 1A, and the transfer master 112 has the thickness distribution illustrated in FIG. 5A.

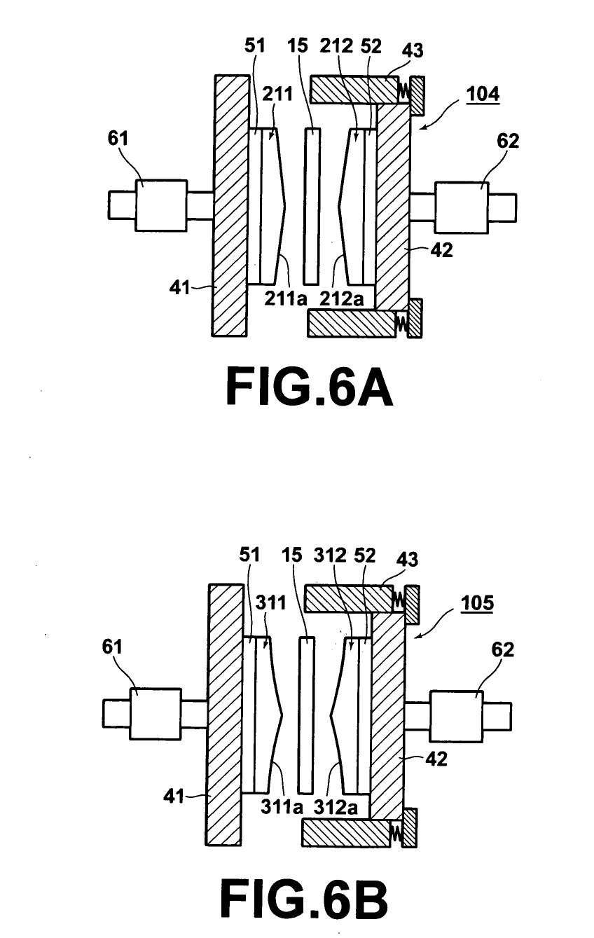

FIG. 6A shows a modification, in which a transfer master 211 and a transfer master 212 are supported within a transfer holder 104. In this modification, as in the first embodiment described above, each of the transfer masters 211 and 212 has a thickness distribution, such that the thickness of the transfer master becomes large continuously from the outer periphery side toward the center point side, the center point side being protruded to a maximum height. However, in this modification, each of a transfer surface 211a of the transfer master 211 and a transfer surface 212a of the transfer master 212 has an approximately circular cone-like convex surface shape, which is symmetric with respect to the center point of the transfer slave material 15.

FIG. 6B shows a modification, in which a transfer master 311 and a transfer master 312 are supported within a transfer holder 105. In this modification, as in the first embodiment described above, each of the transfer masters 311 and 312 has a thickness distribution, such that the thickness of the transfer master becomes large continuously from the outer periphery side toward the center point side, the center point side being protruded to a maximum height. However, in this modification, each of a transfer surface 311a of the transfer master 311 and a transfer surface 312a of the transfer master 312 has an approximately circular cone-like convex surface shape, which is symmetric with respect to the center point of the transfer slave material 15.

Also, each of the transfer masters 11 and 12 described above may be constituted such that each of the transfer masters 11 and 12 has a thickness distribution symmetric with respect to the diametral line of the transfer master, and such that each of the transfer surface 11a of the transfer master 11 and the transfer surface 12a of the transfer master 12 has a surface shape symmetric with respect to the diametral line of the transfer master. With the constitution described above, the close contact of each of the transfer masters 11 and 12 and the transfer slave material 15 is capable of proceeding symmetrically in accordance with the surface shape of the transfer surface, and the intra-plane order of the occurrence of the close contact is capable of being regulated accurately. Examples of the surface shapes symmetric with respect to the diametral line include a paraboloidal shape, a subcylindrical surface shape, and a saddle surface shape.

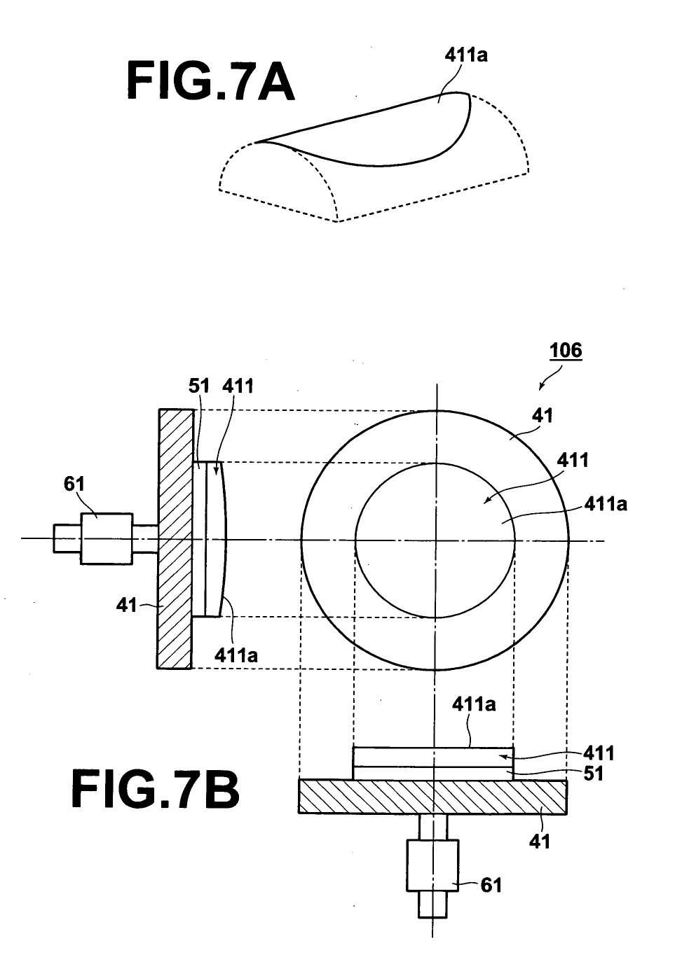

FIGS. 7A and 7B shows a modification, in which a transfer master 411 having a subcylindrical transfer surface 411a and a transfer master 412 (not shown) having a subcylindrical transfer surface 412a (not shown) are supported within a transfer holder 106. FIG. 7A is a perspective view showing the subcylindrical transfer surface 411a of the transfer master 411. FIG. 7B is an explanatory view containing a plan view showing the transfer master 411 having the subcylindrical transfer surface 411a shown in FIG. 7A and the support member 41, which plan view is taken from the transfer surface side of the transfer master 411, and two side views showing the transfer master 411 and the support member 41, which side views are taken from directions varying by an angle of 90° from each other. (In FIG. 7B, the support member 41 is illustrated by the sectional view.) The constitution on the side of the support member 42 is identical with the constitution on the side of the support member 41 illustrated in FIGS. 7A and 7B.

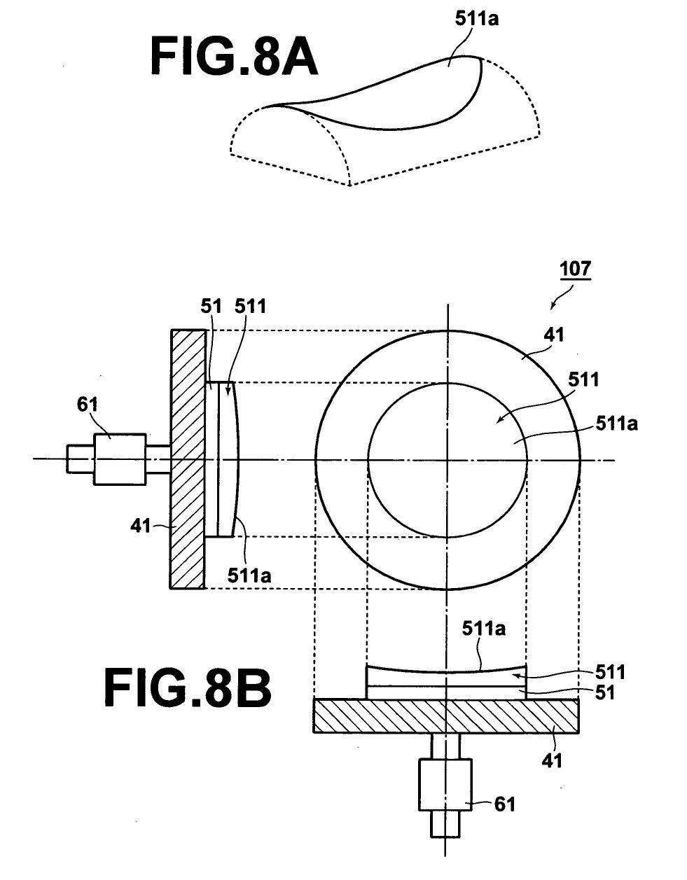

FIGS. 8A and 8B shows a modification, in which a transfer master 511 having a saddle surface-shaped transfer surface 511a and a transfer master 512 (not shown) having a saddle surface-shaped transfer surface 512a (not shown) are supported within a transfer holder 107. FIG. 8A is a perspective view showing the saddle surface-shaped transfer surface 511a of the transfer master 511. FIG. 8B is an explanatory view containing a plan view showing the transfer master 511 having the saddle surface-shaped transfer surface 511a shown in FIG. 8A and the support member 41, which plan view is taken from the transfer surface side of the transfer master 511, and two side views showing the transfer master 511 and the support member 41, which side views are taken from directions varying by an angle of 900 from each other. (In FIG. 8B, the support member 41 is illustrated by the sectional view.) The saddle surface-shaped transfer surface 511a of the transfer master 511 (or the saddle surface-shaped transfer surface 512a of the transfer master 512) has a concave-convex surface shape, such that two sites on the outer periphery, which sites lie on an identical diametral line, are protruded to a maximum height, and sites deviated by an angle of 90° from the sites protruded to the maximum height are depressed to a minimum height. With the constitution described above, the close contact of each of the transfer masters 511 and 512 and the transfer slave material 15 with each other starts from the two sites on the outer periphery of each of the transfer surfaces 511a and 512a, which sites lie on the identical diametral line and are protruded to the maximum height, and successively proceeds from the sides having a high surface height toward the sides having a low surface height.

Each of the transfer masters 11 and 12 should preferably be constituted such that the thickness of the transfer master alters continuously from the thick side to the thin side. Alternatively, each of the transfer masters 11 and 12 may be constituted such that the thickness of the transfer master alters by stages from the thick side to the thin side.

The technique for securing each of the transfer masters 11 and 12 to the corresponding one of the support members 41 and 42 is not limited to the securing by suction. For example, a technique for securing by use of an adhesive agent, magnetic force, or the like, may be employed.

In each of the transfer holders 101 through 107 described above, one pair of the transfer masters, each of which has the thickness distribution, are supported. Alternatively, at least either one of the pair of the transfer masters may have the thickness distribution. In such cases, the close contact is capable of being achieved more appropriately than with conventional techniques, in which only the flat transfer masters having no thickness distribution are utilized.

In the first embodiment described above, the surface information carried by the transfer master 11 is transferred to one of the opposite surfaces of the transfer slave material 15, and the surface information carried by the transfer master 12 is transferred to the other surface of the transfer slave material 15. The transfer apparatus in accordance with the present invention may also be constituted for a transfer operation for transferring the surface information to only one surface of the transfer slave material 15. With the transfer operation for transferring the surface information to only one surface of the transfer slave material 15, firstly, the pair of the support members 41 and 42 are located at the positions spaced away from each other, and the one transfer master 11 and the transfer slave material 15 are located so as to stand facing each other between the pair of the support members 41 and 42. Thereafter, the pair of the support members 41 and 42 are caused to come close to each other, and the transfer master 11 and the transfer slave material 15 are thus brought into close contact with each other under pressure. In this manner, the transfer information carried by the transfer master 11 is transferred to the one surface of the transfer slave material 15.

The transfer master, the transfer holder, and the transfer apparatus employed in the first embodiment in accordance with the present invention are appropriate particularly for magnetic transfer, in which strict position adjustments are required. The transfer master, the transfer holder, and the transfer apparatus employed in the first embodiment in accordance with the present invention are applicable also to various kinds of transfer techniques, in which the transfer master and the transfer slave material are brought into close contact with each other, and information, such as magnetic information or shape information, is transferred from the transfer master to the transfer slave material.

### Second embodiment

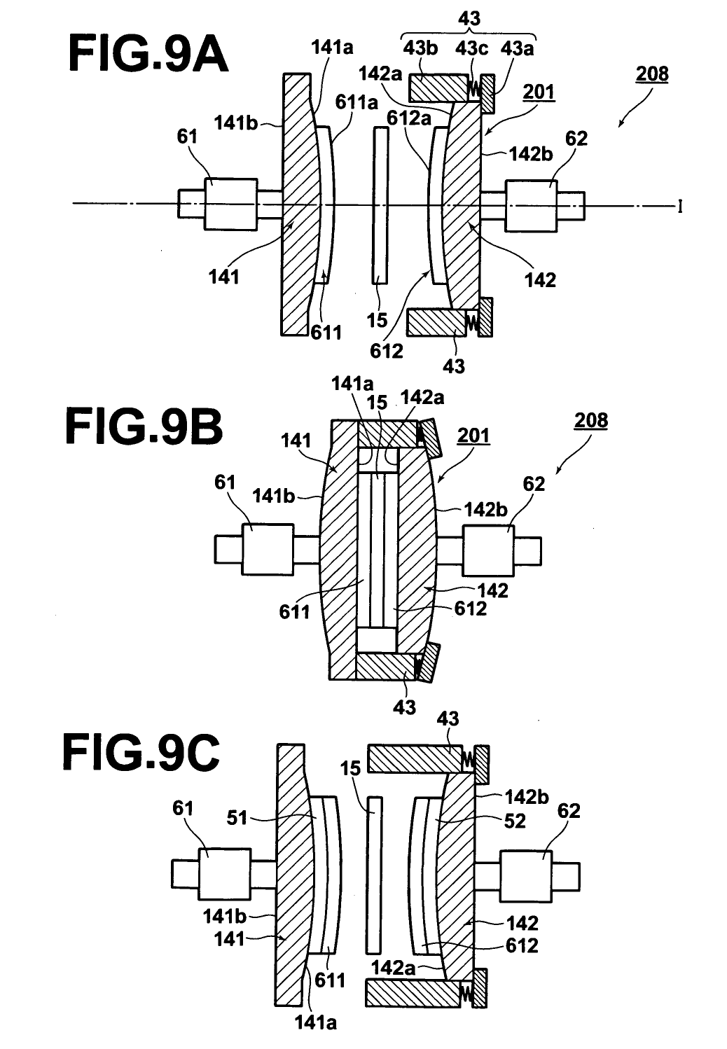

A second embodiment of the transfer apparatus in accordance with the present invention will be described hereinbelow by taking magnetic transfer to opposite surfaces of a transfer slave material as an example. FIG. 9A is a side view showing a second embodiment of the transfer apparatus in accordance with the present invention in a state in which a pair of support members take positions most spaced away from each other. FIG. 9B is a side view showing the second embodiment of the transfer apparatus in accordance with the present invention in a state in which the pair of the support members take positions closest to each other. In FIGS. 9A and 9B, a transfer holder is illustrated as a sectional view. In FIGS. 9A and 9B (and FIG. 9C that follows), similar elements are numbered with the same reference numerals with respect to FIG. 1A and FIG. 2A.

In the second embodiment, the constitution of each of a pair of support members, which constitutes a transfer holder, is devised in specific ways, such that the close contact of each of transfer masters and the transfer slave material with each other is capable of starting from a specific site on the surface of the transfer slave material and successively occurring over the entire area of the surface of the transfer slave material.

With reference to FIGS. 9A and 9B, in this embodiment of a transfer apparatus 208, as in the first embodiment described above, a transfer holder 201 comprises a pair of support members 141 and 142, which are capable of taking positions close to each other and positions spaced away from each other. The pair of the support members 141 and 142 are adapted to support a pair of transfer masters 611 and 612 and the transfer slave material 15 between the pair of the support members 141 and 142. An inside surface of the support member 141 acts as a support surface 141a for supporting the transfer masters 611 and 612 and the transfer slave material 15. Also, an inside surface of the support member 142 acts as a support surface 142a for supporting the transfer masters 611 and 612 and the transfer slave material 15. Each of the support member 141 and the support member 142 has a plurality of suction holes (not shown) connected to suction means, such as a pressure reducing pump. The transfer master 611 is secured by suction to the support surface 141a of the support member 141. Also, the transfer master 612 is secured by suction to the support surface 142a of the support member 142. The shapes of the suction holes may be selected from various shapes, such as cylindrical shapes and groove-like shapes.

FIG. 9C is a side view showing a modification of the second embodiment of the transfer apparatus in accordance with the present invention in a state in which a pair of support members take positions most spaced away from each other. As illustrated in FIG. 9C, the constitution described above should preferably be modified such that the elastic material 51 having the plurality of the suction holes (not shown) is secured to the support surface 141a of the support member 141, and the elastic material 52 having the plurality of the suction holes (not shown) is secured to the support surface 142a of the support member 142. In this modification, the transfer master 611 is secured by suction via the elastic material 51 to the support member 141, and the transfer master 612 is secured by suction via the elastic material 52 to the support member 142. With the modification provided with the elastic materials 51 and 52, it becomes possible to compensate for fine variations of the thicknesses of the transfer masters 611 and 612 and the transfer slave material 15 and fine variations of the shapes of the support surfaces 141a and 142a of the support members 141 and 142. Therefore, the transfer masters 611 and 612 are capable of being accurately brought into close contact with the transfer slave material 15. The utilization of the elastic materials 51 and 52 is efficient particularly in cases where the area of the transfer slave material 15 is large. The effect described above is capable of being obtained with the constitution, in which the elastic material is located on the support surface of at least either one of the support members 141 and 142.

The transfer holder 201 is adapted for use in a transfer operation described below. Specifically, firstly, as illustrated in FIG. 9A, the pair of the support members 141 and 142 are located at the positions spaced away from each other, and the transfer slave material 15 is supplied to the position between the transfer master 611, which has been secured to the support member 141, and the transfer master 612, which has been secured to the support member 142. Each of the pair of the transfer masters 611 and 612 and the transfer slave material 15 are thus located so as to stand facing each other. Thereafter, as illustrated in FIG. 9B, the pair of the support members 141 and 142 are caused to come close to each other. The transfer master 611, the transfer slave material 15, and the transfer master 612 are thus brought into close contact with one another under pressure. As described above, the spring member 43c capable of undergoing expansion and contraction is set in the peripheral wall 43. Therefore, at the time at which the close contact of each of the transfer masters 611 and 612 and the transfer slave material 15 with each other is completed, the support member 141 and the peripheral wall 43 come into close contact with each other regardless of the thicknesses of the transfer masters 611 and 612 and the transfer slave material 15, and the region within the transfer holder 201 is sealed.

This embodiment of the transfer apparatus 208 comprises the transfer holder 201 and other apparatus members necessary for the magnetic transfer. By way of example, the transfer apparatus 208 also comprises the transfer slave material accommodating section for accommodating the transfer slave material 15. The transfer apparatus 208 further comprises the conveying means, such as the robot arm, for conveying the transfer slave material 15 from the transfer slave material accommodating section into the region within the transfer holder 201. The transfer apparatus 208 still further comprises the support member moving means for moving at least either one of the pair of the support members 141 and 142 of the transfer holder 201 with respect to the other, such that the pair of the support members 141 and 142 take the positions close to each other and the positions spaced away from each other. The transfer apparatus 208 also comprises the magnetic field applying means for applying the magnetic field to the transfer masters 611 and 612 and the transfer slave material 15, which have been supported by the transfer holder 201, from the outside of the transfer holder 201.

In FIGS. 9A and 9B, as the constituent members of the transfer apparatus 208 other than the transfer holder 201, the pushing members (i.e., the pressure applying means) 61 and 62 alone are illustrated. The pushing members 61 and 62 are the constituent members of the support member moving means. The pushing member 61 is secured to an opposite surface 141b of the support member 141, which surface is opposite to the support surface 141a of the support member 141. The pushing member 62 is secured to an opposite surface 142b of the support member 142, which surface is opposite to the support surface 142a of the support member 142. The pushing members 61 and 62 support the support members 141 and 142, respectively, and push the pair of the support members 141 and 142 in the directions that cause the pair of the support members 141 and 142 to come close to each other.

How each of the support members 141 and 142 in this embodiment is constituted and how each of the transfer masters 611 and 612 and the transfer slave material 15 are brought into close contact with each other will be described hereinbelow.

In this embodiment, each of the support surface 141a of the support member 141 and the support surface 142a of the support member 142 has a subspherical convex surface shape, which is symmetric with respect to the center point of the transfer slave material 15. Each of the support surface 141a of the support member 141 and the support surface 142a of the support member 142 has a surface height distribution, such that the surface height becomes large continuously from the outer periphery side toward the center point side, and such that the center point side is protruded to a maximum height. In FIG. 9A, the center axis line is represented by the reference numeral I.

A maximum difference in surface height of each of regions of the support surface 141a of the support member 141 and the support surface 142a of the support member 142, which regions correspond to the information transfer accepting region of the transfer slave material 15, should preferably fall within the range of 1 μm to 100 μm, and should more preferably fall within the range of 5 μm to 100 μm. Each of the support surfaces 141a and 142a having the fine surface height distribution described above is capable of being formed accurately with processing, such as lap grinding or superfine processing. When necessary, each of the support surfaces 141a and 142a may be subjected to surface processing. For example, for reduction of frictional force, or the like, each of the support surfaces 141a and 142a may be subjected to surface roughing processing, such as blasting.

Such that the magnetic field may be applied accurately from the exterior of the transfer holder 201 to the transfer masters 611 and 612 and the transfer slave material 15, which have been supported within the transfer holder 201, the thickness of each of the regions of the support members 141 and 142, which regions correspond to the information transfer accepting region of the transfer slave material 15, is ordinarily set at a value on the order of millimeter, and should preferably be at most 10 mm. With respect to the thickness of each of the support members 141 and 142, which thickness is on the order of millimeter, the difference in surface height of each of the support surfaces 141a and 142a is as small as the order of micron. In FIG. 9A, for clearness, the difference in surface height of each of the support surfaces 141a and 142a is illustrated to be larger than the actual difference in surface height.

The transfer master 611 is secured by suction to the support member 141, and the transfer master 612 is secured by suction to the support member 142. Since the support surface 141a of the support member 141 has the surface height distribution described above, the transfer master 611 is supported on the support member 141, such that the transfer master 611 takes on the form corresponding to the surface shape of the support surface 141a of the support member 141. Also, since the support surface 142a of the support member 142 has the surface height distribution described above, the transfer master 612 is supported on the support member 142, such that the transfer master 612 takes on the form corresponding to the surface shape of the support surface 142a of the support member 142. Specifically, the transfer master 611 is supported in the curved form in accordance with the surface height distribution of the support surface 141a, and the transfer master 612 is supported in the curved form in accordance with the surface height distribution of the support surface 142a. As in the cases of the support surface 141a of the support member 141, a transfer surface 611a of the transfer master 611 thus takes on the form of the subspherical convex surface shape, which is symmetric with respect to the center point of the transfer slave material 15. Also, as in the cases of the support surface 142a of the support member 142, a transfer surface 612a of the transfer master 612 thus takes on the form of the subspherical convex surface shape, which is symmetric with respect to the center point of the transfer slave material 15.

With the constitution described above, the close contact with the transfer slave material 15 starts from the inner periphery site on each of the transfer masters 611 and 612, which site is protruded to the maximum height. Specifically, the close contact of the transfer master 611 and the transfer slave material 15 with each other starts from the inner periphery site on the corresponding surface of the transfer slave material 15 and successively occurs toward the outer periphery site and over the entire area of the corresponding surface of the transfer slave material 15. Also, the close contact of the transfer slave material 15 and the transfer master 612 with each other starts from the inner periphery site on the corresponding surface of the transfer slave material 15 and successively occurs toward the outer periphery site and over the entire area of the corresponding surface of the transfer slave material 15.

In this embodiment, as illustrated in FIG. 9B, the material of each of the support members 141 and 142, or the like, is designed such that the maximum difference in surface height of each of the regions of the support surface 141a and the support surface 142a, which regions correspond to the information transfer accepting region of the transfer slave material 15, at the time of the end of the close contact under pressure becomes smaller than the maximum difference in surface height at the time before the close contact starts, and such that each of the support surface 141a and the support surface 142a at the time of the end of the close contact takes on the form of a flat surface or a surface shape close to the flat surface. In such cases, at the time of the end of the close contact, each of the opposite surface 141b of the support member 141, which surface is opposite to the support surface 141a of the support member 141, and the opposite surface 142b of the support member 142, which surface is opposite to the support surface 142a of the support member 142, is pushed out to the outward side and takes on the form of, for example, the convex surface shape as illustrated in FIG. 9B. Due to the close contact under pressure, the difference in surface height of each of the support surface 141a and the support surface 142a becomes smaller than the difference in surface height at the time before the close contact starts, and each of the support surface 141a and the support surface 142a takes on the form of the flat surface or the surface shape close to the flat surface. Therefore, the close contact of each of the transfer masters 611 and 612 and the transfer slave material 15 with each other is capable of occurring accurately over the entire area of each of the transfer surface 611a and the transfer surface 612a.

The inventors have found that, in cases where the maximum difference in surface height of each of the regions of the support surface 141a of the support member 141 and the support surface 142a of the support member 142, which regions correspond to the information transfer accepting region of the transfer slave material 15, is set to be at least 1 μm, preferably at least 5 μm, the intra-plane order of the occurrence of the close contact is capable of being regulated accurately in the manner described above. Also, the inventors have found that, in cases where the maximum difference in surface height of each of the regions of the support surface 141a of the support member 141 and the support surface 142a of the support member 142, which regions correspond to the information transfer accepting region of the transfer slave material 15, is at most 100 μm, the problems are capable of being prevented from occurring in that the transfer master 611 or 612 becomes lifted out of the corresponding support member 141 or 142. The inventors have thus found that, in such cases, the entire area of each of the surface of the transfer master 611, which surface stands facing the support member 141, and the surface of the transfer master 612, which surface stands facing the support member 142, is capable of being accurately kept in close contact with the corresponding support member 141 or 142, and the transfer masters 611 and 612 are capable of being reliably supported on the support members 141 and 142, respectively. Further, the inventors have found that, in cases where the maximum difference in surface height of each of the regions of the support surface 141a of the support member 141 and the support surface 142a of the support member 142, which regions correspond to the information transfer accepting region of the transfer slave material 15, is at most 100 μm, damages of the transfer masters 611 and 612 due to curving are capable of being suppressed.

In this embodiment, the pressure, which is applied by the pushing members 61 and 62 (i.e., the pressure applying means) to the transfer holder 201, should preferably fall within the range of 0.05 MPa to 10.0 MPa. In the cases of the magnetic transfer, the pressure, which is applied by the pushing members 61 and 62 (i.e., the pressure applying means) to the transfer holder 201, should more preferably fall within the range of 0.05 MPa to 1.0 MPa. If the applied pressure is markedly low, there will be the risk that the close contact of each of the transfer masters 611 and 612 and the transfer slave material 15 with each other will become insufficient. If the applied pressure is markedly high, there will be the risk that the speed, with which the close contact of each of the transfer masters 611 and 612 and the transfer slave material 15 with each other occurs, will become markedly high, and the intra-plane order of the occurrence of the close contact will not be capable of being regulated accurately in the manner described above.

In this embodiment, the transfer holder 201 and the transfer apparatus 208 are constituted in the manner described above.

With this embodiment, the transfer holder 201 is constituted such that each of the support surface 141a of the support member 141 and the support surface 142a of the support member 142 has the subspherical convex surface shape, in which the center point side is protruded to the maximum height. Therefore, by virtue of the subspherical convex surface shape of the support surface 141a of the support member 141, the close contact of the transfer surface 611a of the transfer master 611 and the transfer slave material 15 with each other is capable of starting from the inner periphery site on the corresponding surface of the transfer slave material 15 and successively occurring toward the outer periphery site and over the entire area of the corresponding surface of the transfer slave material 15. Also, by virtue of the subspherical convex surface shape of the support surface 142a of the support member 142, the close contact of the transfer surface 611a of the transfer master 611 and the transfer slave material 15 with each other is capable of starting from the inner periphery site on the corresponding surface of the transfer slave material 15 and successively occurring toward the outer periphery site and over the entire area of the corresponding surface of the transfer slave material 15. Further, with the transfer holder 201 employed in this embodiment, the intra-plane order of the occurrence of the close contact of each of the transfer masters 611 and 612 and the transfer slave material 15 with each other is capable of being regulated accurately. Therefore, it is possible to prevent the problems from occurring with regard to air confinement between the transfer surface 611a or 612a and the transfer accepting surface of the transfer slave material 15, and the like. Accordingly, each of the transfer masters 611 and 612 and the transfer slave material 15 are capable of being accurately brought into close contact with each other.

Furthermore, with the embodiment described above, the surface shape of the support surface 141a is symmetric with respect to the center point of the support surface 141a (i.e., rotationally symmetric with respect to the center axis line I). Also, the surface shape of the support surface 142a is symmetric with respect to the center point of the support surface 142a (i.e., rotationally symmetric with respect to the center axis line I). Therefore, the close contact of each of the transfer masters 611 and 612 and the transfer slave material 15 is capable of proceeding reliably from the inner periphery site on each of the corresponding surfaces of the transfer slave material 15 and successively occurring toward the outer periphery site. The close contact is thus capable of proceeding uniformly with respect to the peripheral direction of each of the corresponding surfaces of the transfer slave material 15, and the intra-plane order of the occurrence of the close contact is capable of being regulated accurately.

Also, in the embodiment described above, instead of the transfer masters 611 and 612 being devised in specific ways, the constitution on the side of the transfer holder 201 is devised in the specific ways. Therefore, the embodiment described above has the advantages over the conventional techniques, wherein the transfer master is merely caused to curve, in that the accurate processing of each of the support surface 141a and the support surface 142a for obtaining the structure for regulating the intra-plane order of the occurrence of the close contact is capable of being performed easily and at a low cost. As described above, each of the support surfaces 141a and 142a is capable of being formed accurately with the processing, such as the lap grinding or the superfine processing. Further, the embodiment described above has the advantages over the conventional techniques in that the shape of each of the support surfaces 141a and 142a for regulating the intra-plane order of the occurrence of the close contact is capable of being kept accurately even under the condition, in which a low pressure is applied to the transfer holder 201 at the initial stage of the start of the close contact of each of the transfer masters 611 and 612 and the transfer slave material 15 with each other. Therefore, the accurate close contact of each of the transfer masters 611 and 612 and the transfer slave material 15 with each other is capable of being obtained reliably.

In the embodiment described above, in cases where the transfer slave material 15 is to be taken out of the transfer holder 201 after the application of the transfer magnetic field H_{du} has been finished, the pressure applied to the transfer holder 201 is released. At this time, restoring force for the restoration to the original shape occurs with each of the support members 141 and 142 and each of the transfer masters 611 and 612 having been secured to the support members 141 and 142, respectively. The restoring force acts as the force for separating the transfer slave material 15 from each of the transfer surface 611a of the transfer master 611 and the transfer surface 612a of the transfer master 612. Therefore, the transfer slave material 15 is capable of being separated easily from each of the transfer surface 611a of the transfer master 611 and the transfer surface 612a of the transfer master 612 and is capable of being taken out easily from the transfer holder 201.

In the embodiment described above, wherein the transfer apparatus 208 is provided with the transfer holder 201, accurate magnetic transfer is capable of being performed. In cases where the transfer apparatus 208 in this embodiment is utilized, a magnetic recording medium having been subjected to the accurate magnetic transfer is capable of being produced reliably.

### Modifications of the Second Embodiment

The second embodiment described above may be modified in various ways.

Specifically, each of the support member 141 having the support surface 141a and the support member 142 having the support surface 142a may be replaced by a support member having a support surface, which has the surface height distribution such that a specific site is protruded to a maximum height. In such cases, the same effects as those with the embodiment described above are capable of being obtained.

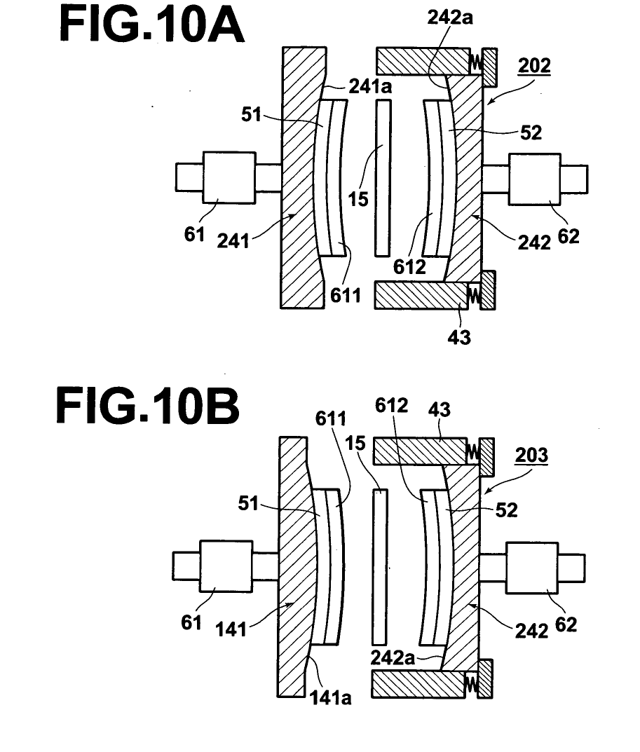

For example, FIG. 10A shows a modification, in which a transfer holder 202 is provided with a pair of support member 241 and a support member 242. In FIG. 10A (and FIG. 10B to FIG. 13B that follow), similar elements are numbered with the same reference numerals with respect to FIG. 9A and FIG. 9C. In this modification, each of a support surface 241a of the support member 241 and a support surface 242a of the support member 242 has a subspherical concave surface shape, which is symmetric with respect to the center point of the transfer slave material 15. Each of the support surface 241a of the support member 241 and the support surface 242a of the support member 242 has a surface height distribution, such that the surface height becomes large continuously from the center point side toward the outer periphery side, and such that the outer periphery site is protruded to a maximum height. With the constitution shown in FIG. 10A, the close contact of each of the transfer masters 611 and 612 and the transfer slave material 15 with each other starts from the outer periphery site on the transfer slave material 15 and successively occurs toward the inner periphery site.

FIG. 10B shows a modification, in which a transfer holder 203 is provided with a pair of the support member 141 and the support member 242 having different support surface shapes. In the modification shown in FIG. 10B, the support surface 141a of the support member 141 has the convex surface shape illustrated in FIG. 9A, and the support surface 242a of the support member 242 has the concave surface shape illustrated in FIG. 10A.

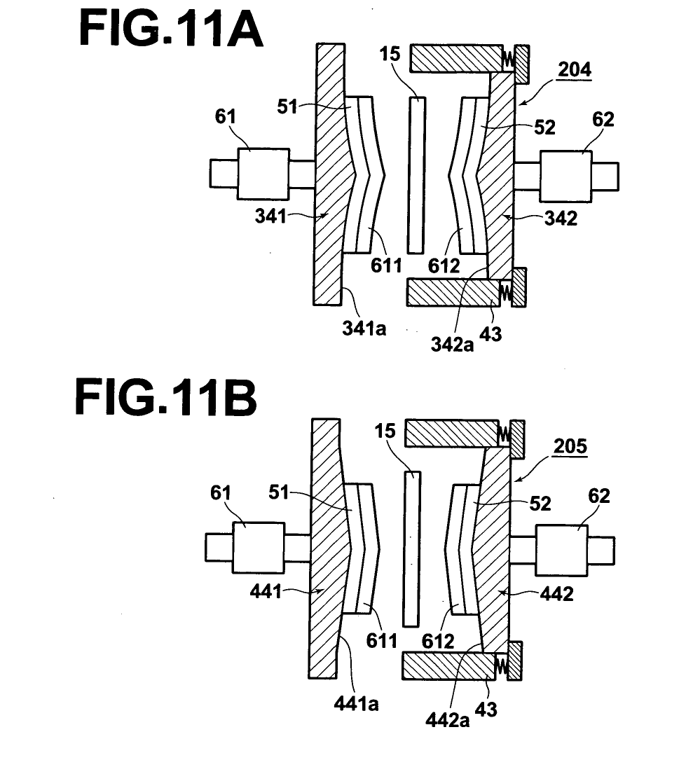

FIG. 11A shows a modification, in which a transfer holder 204 is provided with a pair of a support member 341 and a support member 342. In the modification shown in FIG. 11A, each of a support surface 341a of the support member 341 and a support surface 342a of the support member 342 has an approximately circular cone-like convex surface shape, which is symmetric with respect to the center point of the transfer slave material 15. Each of the support surface 341a of the support member 341 and a support surface 342a of the support member 342 has a surface height distribution, such that the surface height becomes large continuously from the outer periphery side toward the center point side, and such that the center point side is protruded to a maximum height.

FIG. 11B shows a modification, in which a transfer holder 205 is provided with a pair of a support member 441 and a support member 442. In the modification shown in FIG. 11B, each of a support surface 441a of the support member 441 and a support surface 442a of the support member 442 has an approximately circular cone-like convex surface shape, which is symmetric with respect to the center point of the transfer slave material 15. Each of the support surface 441a of the support member 441 and a support surface 442a of the support member 442 has a surface height distribution, such that the surface height becomes large continuously from the outer periphery side toward the center point side, and such that the center point side is protruded to a maximum height.

Also, each of the support members 141 and 142 described above may be constituted such that each of the support surface 141a of the support member 141 and the support surface 142a of the support member 142 has a surface shape symmetric with respect to the diametral line of the transfer slave material 15. With the constitution described above, the close contact of each of the transfer masters 611 and 612 and the transfer slave material 15 is capable of proceeding symmetrically in accordance with the surface shape of the support surface, and the intra-plane order of the occurrence of the close contact is capable of being regulated accurately. Examples of the surface shapes symmetric with respect to the diametral line of the transfer slave material 15 include a paraboloidal shape, a subcylindrical surface shape, and a saddle surface shape.

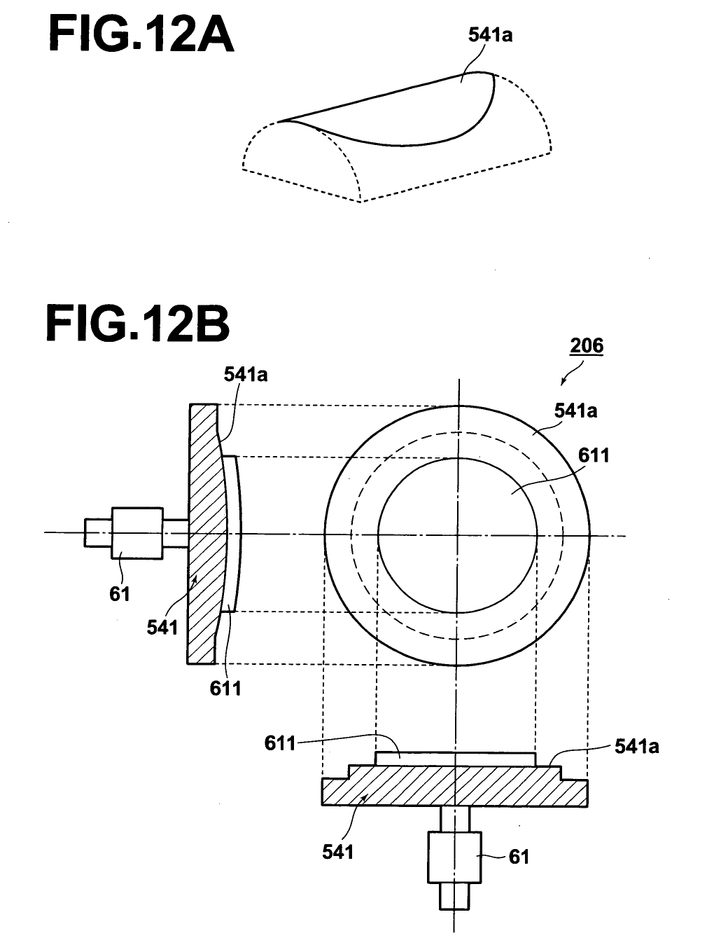

FIGS. 12A and 12B shows a modification, in which a transfer holder 206 is provided with a pair of a support member 541, which has a subcylindrical support surface 541a, and a support member 542 (not shown), which has a subcylindrical support surface 542a (not shown). FIG. 12A is a perspective view showing the subcylindrical support surface 541a of the support member 541. FIG. 12B is an explanatory view containing a plan view showing the transfer master 611 and the support member 541 having the subcylindrical support surface 541a shown in FIG. 12A, which plan view is taken from the transfer surface side of the transfer master 611, and two side views showing the transfer master 611 and the support member 541, which side views are taken from directions varying by an angle of 90° from each other. (In FIG. 12B, the support member 541 is illustrated by the sectional view.) The constitution on the side of the support member 542 is identical with the constitution on the side of the support member 541 illustrated in FIGS. 12A and 12B.

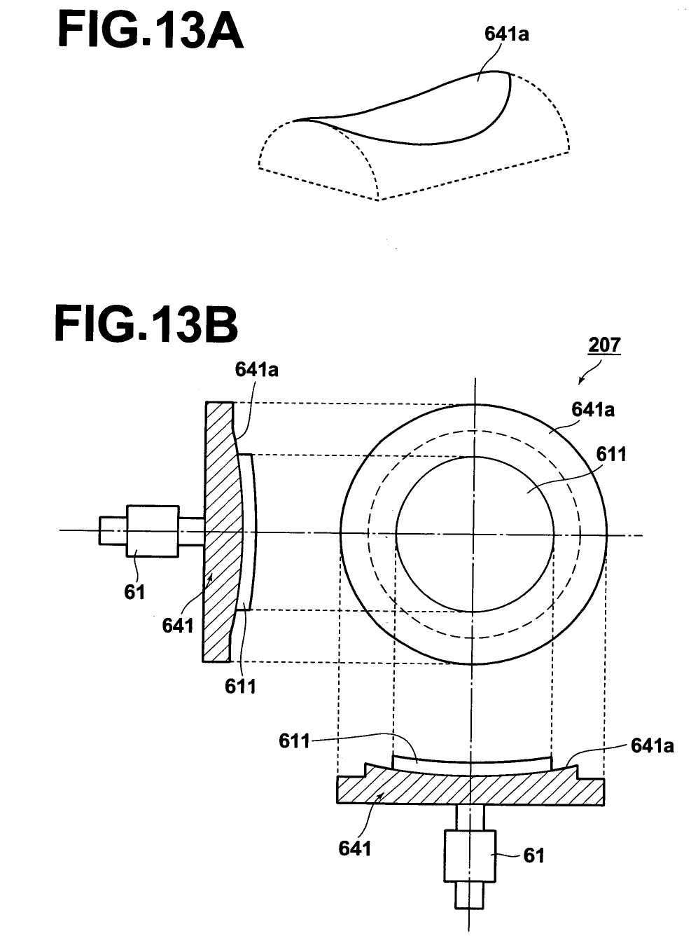

FIGS. 13A and 13B shows a modification, in which a transfer holder 207 is provided with a pair of a support member 641, which has a saddle surface-shaped support surface 641a, and a support member 642 (not shown), which has a saddle surface-shaped support surface 642a (not shown). FIG. 13A is a perspective view showing the saddle surface-shaped support surface 641a of the support member 641. FIG. 13B is an explanatory view containing a plan view showing the transfer master 611 and the support member 641 having the saddle surface-shaped support surface 641a shown in FIG. 13A, which plan view is taken from the transfer surface side of the transfer master 611, and two side views showing the transfer master 611 and the support member 641, which side views are taken from directions varying by an angle of 90° from each other. (In FIG. 13B, the support member 641 is illustrated by the sectional view.) The saddle surface-shaped support surface 641a of the support member 641 (or the saddle surface-shaped support surface 642a of the support member 642) has a concave-convex surface shape, such that two sites on the outer periphery, which sites lie on an identical diametral line, are protruded to a maximum height, and sites deviated by an angle of 90° from the sites protruded to the maximum height are depressed to a minimum height. With the constitution described above, the close contact of each of the transfer masters 611 and 612 and the transfer slave material 15 with each other starts from the two sites on the outer periphery of each of the support surfaces 641a and 642a, which sites lie on the identical diametral line and are protruded to the maximum height, and successively proceeds from the sides having a high surface height toward the sides having a low surface height.

Each of the support members 141 and 142 described above should preferably be constituted such that the surface height of each of the support surfaces 141a and 142a alters continuously from the side having a high surface height toward the side having a low surface height. Alternatively, each of the support members 141 and 142 may be constituted such that the surface height of each of the support surfaces 141a and 142a alters by stages from the side having a high surface height toward the side having a low surface height.

Also, either one of the support surface 141a of the support member 141 and the support surface 142a of the support member 142 described above may be constituted as a flat support surface. In cases where at least either one of the support surface 141a of the support member 141 and the support surface 142a of the support member 142 described above has the surface height distribution, such that a specific site on the support surface is protruded to a maximum height, the close contact of at least either one of the transfer masters 611 and 612 and the transfer slave material 15 with each other is capable of starting from the specific site on the corresponding surface of the transfer slave material 15 and successively occurring over the entire area of the corresponding surface of the transfer slave material 15. In such cases, the close contact is capable of being achieved more appropriately than with conventional techniques, wherein a transfer holder is provided with a pair of support members, each of which has a flat support surface.

The technique for securing each of the transfer masters 611 and 612 to the corresponding one of the support members 141 and 142 is not limited to the securing by suction. For example, a technique for securing by use of an adhesive agent, magnetic force, or the like, may be employed.

In the second embodiment described above, the surface information carried by the transfer master 611 is transferred to one of the opposite surfaces of the transfer slave material 15, and the surface information carried by the transfer master 612 is transferred to the other surface of the transfer slave material 15. The transfer apparatus in accordance with the present invention may also be constituted for a transfer operation for transferring the surface information to only one surface of the transfer slave material 15. With the transfer operation for transferring the surface information to only one surface of the transfer slave material 15, firstly, the pair of the support members 141 and 142 are located at the positions spaced away from each other, and the one transfer master 611 and the transfer slave material 15 are located so as to stand facing each other between the pair of the support members 141 and 142. Thereafter, the pair of the support members 141 and 142 are caused to come close to each other, and the transfer master 611 and the transfer slave material 15 are thus brought into close contact with each other under pressure. In this manner, the transfer information carried by the transfer master 611 is transferred to the one surface of the transfer slave material 15.

In the cases of the transfer operation for transferring the surface information to only one surface of the transfer slave material 15, at least either one of the support surface 141a of the support member 141 and the support surface 142a of the support member 142 described above may have the surface height distribution, such that a specific site on the support surface is protruded to a maximum height. Also, the close contact of the one transfer master 611 and the transfer slave material 15 with each other may be caused to occur, such that the close contact starts from the specific site on the corresponding surface of the transfer slave material 15 and successively occurs over the entire area of the corresponding surface of the transfer slave material 15. In such cases, the same effects as those with the transfer to the opposite surfaces of the transfer slave material 15 are capable of being obtained. In the cases of the transfer operation for transferring the surface information to only one surface of the transfer slave material 15, ordinarily, the one transfer master 611 is secured to the support member 141 (or the support member 142), the transfer slave material 15 is supplied to the transfer surface 611a of the transfer master 611 in this state, and the transfer master 611 and the transfer slave material 15 are brought into close contact with each other. Alternatively, the transfer slave material 15 may be secured to the support member 141 (or the support member 142), the one transfer master 611 may be supplied to the surface of the transfer slave material 15 in this state, and the transfer master 611 and the transfer slave material 15 may be brought into close contact with each other.

The transfer holder and the transfer apparatus employed in the second embodiment in accordance with the present invention are appropriate particularly for magnetic transfer, in which strict position adjustments are required. The transfer holder and the transfer apparatus employed in the second embodiment in accordance with the present invention are applicable also to various kinds of transfer techniques, in which the transfer master and the transfer slave material are brought into close contact with each other, and information, such as magnetic information or shape information, is transferred from the transfer master to the transfer slave material.

### Third Embodiment

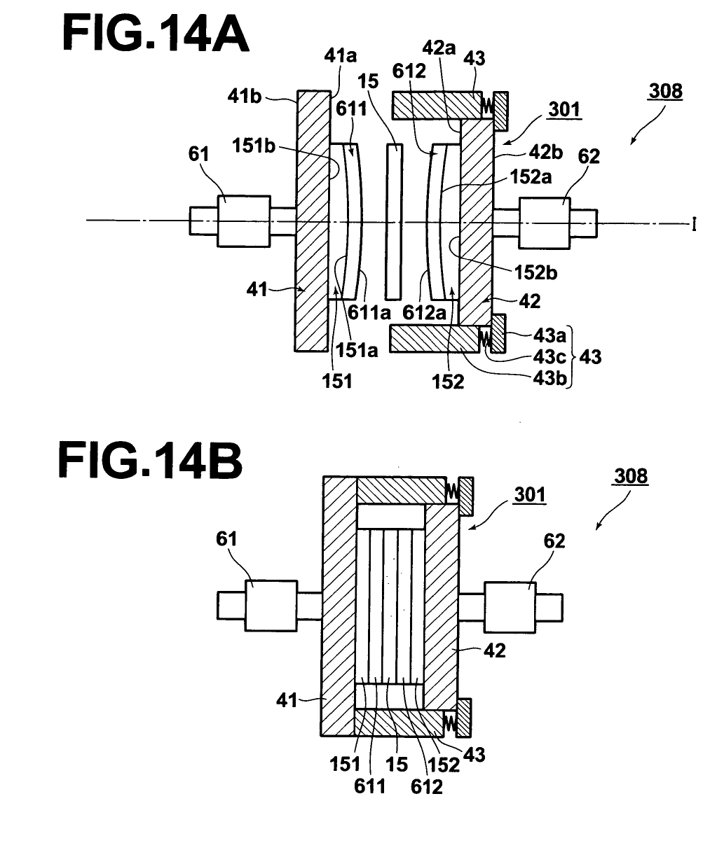

A third embodiment of the transfer apparatus in accordance with the present invention will be described hereinbelow by taking magnetic transfer to opposite surfaces of a transfer slave material as an example. FIG. 14A is a side view showing a third embodiment of the transfer apparatus in accordance with the present invention in a state in which a pair of support members take positions most spaced away from each other. FIG. 14B is a side view showing the third embodiment of the transfer apparatus in accordance with the present invention in a state in which the pair of the support members take positions closest to each other. In FIGS. 14A and 14B, a transfer holder is illustrated as a sectional view. In FIGS. 14A and 14B, similar elements are numbered with the same reference numerals with respect to FIG. 1A and FIG. 9A.

In the third embodiment, the constitution of each of elastic materials, which constitutes a transfer holder, is devised in specific ways, such that the close contact of each of transfer masters and the transfer slave material with each other is capable of starting from a specific site on the surface of the transfer slave material and successively occurring over the entire area of the surface of the transfer slave material.

With reference to FIGS. 14A and 14B, in this embodiment of the transfer apparatus 308, a transfer holder 301 comprises the pair of the support members 41 and 42, which are capable of taking positions close to each other and positions spaced away from each other. The pair of the support members 41 and 42 are adapted to support the pair of the transfer masters 611 and 612 and the transfer slave material 15 between the pair of the support members 41 and 42. The inside surface of the support member 41 acts as the support surface 41a for supporting the transfer masters 611 and 612 and the transfer slave material 15. Also, the inside surface of the support member 42 acts as the support surface 42a for supporting the transfer masters 611 and 612 and the transfer slave material 15.

In this embodiment, an elastic material 151 is secured to the support surface 41a of the support member 41. Also, an elastic material 152 is secured to the support surface 42a of the support member 42. Each of the elastic materials 151 and 152 is made from a material, which is softer than the materials of the transfer masters 611 and 612 and the support members 41 and 42 and has shape restoring characteristics (i.e., elasticity). Examples of the materials for the elastic materials 151 and 152 include fluoro-rubber, urethane rubber, nitrile rubber, ethylene-propylene rubber, silicone rubber, neoprene rubber, Viton rubber, and butadiene rubber. The elastic materials 151 and 152 act to compensate for fine variations of the thicknesses of the transfer masters 611 and 612 and the transfer slave material 15 and fine variations of the shapes of the support surfaces 41a and 42a of the support members 41 and 42, such that the transfer masters 611 and 612 are capable of being accurately brought into close contact with the transfer slave material 15. In this embodiment, each of the elastic materials 151 and 152 also acts as the member for regulating the intra-plane order of occurrence of close contact of each of the transfer masters 611 and 612 and the transfer slave material 15 with each other.

Each of the support member 41 and the support member 42 has the plurality of the suction holes (not shown) connected to the suction means, such as the pressure reducing pump, for a suction mechanism. Also, each of the elastic materials 151 and 152 has a plurality of suction holes (not shown). The transfer master 611 is secured by suction via the elastic material 151 to the support surface 41a of the support member 41. Also, the transfer master 612 is secured by suction via the elastic material 152 to the support surface 42a of the support member 42. The shapes of the suction holes of the support members 141 and 142 and the suction holes of the elastic materials 151 and 152 maybe selected from various shapes, such as cylindrical shapes and groove-like shapes. Besides the suction holes (ordinarily, through-holes), each of the elastic materials 151 and 152 may also have holes (through-holes or non-through-holes), which do not contribute to the securing by suction of each of the transfer masters 611 and 612, such that, for example, an apparent modulus of elasticity may be reduced.

The transfer holder 301 is adapted for use in a transfer operation described below. Specifically, firstly, as illustrated in FIG. 14A, the pair of the support members 41 and 42 are located at the positions spaced away from each other, and the transfer slave material 15 is supplied to the position between the transfer master 611, which has been secured to the support member 41, and the transfer master 612, which has been secured to the support member 42. Each of the pair of the transfer masters 611 and 612 and the transfer slave material 15 are thus located so as to stand facing each other. Thereafter, as illustrated in FIG. 14B, the pair of the support members 41 and 42 are caused to come close to each other. The transfer master 611, the transfer slave material 15, and the transfer master 612 are thus brought into close contact with one another under pressure. As described above, the spring member 43c capable of undergoing expansion and contraction is set in the peripheral wall 43. Therefore, at the time at which the close contact of each of the transfer masters 611 and 612 and the transfer slave material 15 with each other is completed, the support member 41 and the peripheral wall 43 come into close contact with each other regardless of the thicknesses of the transfer masters 611 and 612 and the transfer slave material 15, and the region within the transfer holder 301 is sealed.

This embodiment of the transfer apparatus 308 comprises the transfer holder 301 and other apparatus members necessary for the magnetic transfer. By way of example, the transfer apparatus 308 also comprises the transfer slave material accommodating section for accommodating the transfer slave material 15. The transfer apparatus 308 further comprises the conveying means, such as the robot arm, for conveying the transfer slave material 15 from the transfer slave material accommodating section in to the region within the transfer holder 301. The transfer apparatus 308 still further comprises the support member moving means for moving at least either one of the pair of the support members 41 and 42 of the transfer holder 301 with respect to the other, such that the pair of the support members 41 and 42 take the positions close to each other and the positions spaced away from each other. The transfer apparatus 308 also comprises the magnetic field applying means for applying the magnetic field to the transfer masters 611 and 612 and the transfer slave material 15, which have been supported by the transfer holder 301, from the outside of the transfer holder 301.

In FIGS. 14A and 14B, as the constituent members of the transfer apparatus 308 other than the transfer holder 301, the pushing members (i.e., the pressure applying means) 61 and 62 alone are illustrated. The pushing members 61 and 62 are the constituent members of the support member moving means. The pushing member 61 is secured to the opposite surface 41b of the support member 41, which surface is opposite to the support surface 41a of the support member 41. The pushing member 62 is secured to the opposite surface 42b of the support member 42, which surface is opposite to the support surface 42a of the support member 42. The pushing members 61 and 62 support the support members 41 and 42, respectively, and push the pair of the support members 41 and 42 in the directions that cause the pair of the support members 41 and 42 to come close to each other.

How each of the elastic materials 151 and 152 in this embodiment is constituted and how each of the transfer masters 611 and 612 and the transfer slave material 15 are brought into close contact with each other will be described hereinbelow.

In this embodiment, each of the elastic materials 151 and 152 has a thickness distribution, such that the thickness of the elastic material becomes large continuously from the outer periphery side toward the center point side, the center point side having the largest thickness. Each of the support surface 41a of the support member 41 and the support surface 42a of the support member 42 is flat. Therefore, when the elastic material 151, which is softer than the support member 41, has been secured by suction to the support member 41, an opposite surface 151b of the elastic material 151, which surface is opposite to a support surface 151a of the elastic material 151 and stands facing the side of the support member 41, becomes flat, and the support surface 151a of the elastic material 151, which surface supports the transfer master 611, takes the surface shape corresponding to the thickness distribution of the elastic material 151. Also, when the elastic material 152, which is softer than the support member 42, has been secured by suction to the support member 42, an opposite surface 152b of the elastic material 152, which surface is opposite to a support surface 152a of the elastic material 152 and stands facing the side of the support member 42, becomes flat, and the support surface 152a of the elastic material 152, which surface supports the transfer master 612, takes the surface shape corresponding to the thickness distribution of the elastic material 152. In this embodiment, each of the support surface 151a of the elastic material 151 and the support surface 152a of the elastic material 152 has a subspherical convex surface shape, which is symmetric with respect to the center point of the transfer slave material 15. Each of the support surface 151a of the elastic material 151 and the support surface 152a of the elastic material 152 has a surface height distribution, such that the surface height becomes large continuously from the outer periphery side toward the center point side, and such that the center point side is protruded to a maximum height. In FIG. 14A, the center axis line is represented by the reference numeral I.

A maximum difference in thickness of each of regions of the elastic material 151 and the elastic material 152, which regions correspond to the information transfer accepting region of the transfer slave material 15, should preferably fall within the range of 1 μm to 100 μm, and should more preferably fall within the range of 5 μm to 100 μm. Each of the elastic materials 151 and 152 having the fine thickness distribution described above is capable of being formed accurately with processing, such as grinding, cutting, water jet processing, or press processing. When necessary, the one surface or the opposite surfaces of each of the elastic materials 151 and 152 may be subjected to surface processing. For example, for reduction of frictional force, or the like, each of the elastic materials 151 and 152 may be subjected to surface roughing processing, such as blasting.

Such that the magnetic field may be applied accurately from the exterior of the transfer holder 301 to the transfer masters 611 and 612 and the transfer slave material 15, which have been supported within the transfer holder 301, the thickness of each of the regions of the support members 41 and 42, which regions correspond to the information transfer accepting region of the transfer slave material 15, is ordinarily set at a value on the order of millimeter, and should preferably be at most 10 mm. With respect to the thickness of each of the support members 41 and 42, which thickness is on the order of millimeter, the thickness distribution of each of the elastic materials 151 and 152 is as narrow as the order of micron. In FIG. 14A, for clearness, the thickness distribution of each of the elastic materials 151 and 152 is illustrated to be wider than the actual thickness distribution.

The transfer master 611 is secured by suction via the elastic material 151 to the support member 41, and the transfer master 612 is secured by suction via the elastic material 152 to the support member 42. Since the elastic material 151 has the thickness distribution described above, the transfer master 611 is supported on the support member 41, such that the transfer master 611 takes on the form corresponding to the surface shape of the support surface 151a of the elastic material 151. Also, since the elastic material 152 has the thickness distribution described above, the transfer master 612 is supported on the support member 42, such that the transfer master 612 takes on the form corresponding to the surface shape of the support surface 152a of the elastic material 152. Specifically, the transfer master 611 is supported in the curved form in accordance with the surface height distribution of the support surface 151a of the elastic material 151, and the transfer master 612 is supported in the curved form in accordance with the surface height distribution of the support surface 152a of the elastic material 152. As in the cases of the support surface 151a of the elastic material 151 having been secured to the support member 41, the transfer surface 611a of the transfer master 611 thus takes on the form of the subspherical convex surface shape, which is symmetric with respect to the center point of the transfer slave material 15. Also, as in the cases of the support surface 152a of the elastic material 152 having been secured to the support member 42, the transfer surface 612a of the transfer master 612 thus takes on the form of the subspherical convex surface shape, which is symmetric with respect to the center point of the transfer slave material 15.

With the constitution described above, the close contact with the transfer slave material 15 starts from the inner periphery site on each of the transfer masters 611 and 612, which site is protruded to the maximum height. Specifically, the close contact of the transfer master 611 and the transfer slave material 15 with each other starts from the inner periphery site on the corresponding surface of the transfer slave material 15 and successively occurs toward the outer periphery site and over the entire area of the corresponding surface of the transfer slave material 15. Also, the close contact of the transfer slave material 15 and the transfer master 612 with each other starts from the inner periphery site on the corresponding surface of the transfer slave material 15 and successively occurs toward the outer periphery site and over the entire area of the corresponding surface of the transfer slave material 15.

In this embodiment, the elastic materials 151 and 152 are softer than the transfer masters 611 and 612 and the support members 41 and 42. Therefore, as illustrated in FIG. 14B, due to the close contact under pressure of each of the transfer masters 611 and 612 and the transfer slave material 15 with each other, the opposite surfaces of each of the elastic materials 151 and 152 take on the form of flat surfaces or surface shapes close to the flat surfaces. Due to the close contact under pressure, the thickness distribution of each of the elastic materials 151 and 152 becomes narrower than the thickness distribution at the time before the close contact starts, and each of the support surface 151a of the elastic material 151 and the support surface 152a of the elastic material 152 takes on the form of the flat surface or the surface shape close to the flat surface. Therefore, the close contact of each of the transfer masters 611 and 612 and the transfer slave material 15 with each other is capable of occurring accurately over the entire area of each of the transfer surface 611a and the transfer surface 612a.

The inventors have found that, in cases where the maximum difference in thickness of each of the regions of the elastic material 151 and the elastic material 152, which regions correspond to the information transfer accepting region of the transfer slave material 15, is set to be at least 1 μm, preferably at least 5 μm, the intra-plane order of the occurrence of the close contact is capable of being regulated accurately in the manner described above. Also, the inventors have found that, in cases where the maximum difference in thickness of each of the regions of the elastic material 151 and the elastic material 152, which regions correspond to the information transfer accepting region of the transfer slave material 15, is at most 100 μm, the problems are capable of being prevented from occurring in that the transfer master 611 or 612 becomes lifted out of the corresponding elastic material 151 or 152. The inventors have thus found that, in such cases, the entire area of each of the surface of the transfer master 611, which surface stands facing the elastic material 151, and the surface of the transfer master 612, which surface stands facing the elastic material 152, is capable of being accurately kept in close contact with the corresponding elastic material 151 or 152, and the transfer masters 611 and 612 are capable of being reliably supported by the elastic materials 151 and 152 and the support members 41 and 42. Further, the inventors have found that, in cases where the maximum difference in thickness of each of the regions of the elastic material 151 and the elastic material 152, which regions correspond to the information transfer accepting region of the transfer slave material 15, is at most 100 μm, damages of the transfer masters 611 and 612 due to curving are capable of being suppressed.

In this embodiment, the pressure, which is applied by the pushing members 61 and 62 (i.e., the pressure applying means) to the transfer holder 301, should preferably fall within the range of 0.05 MPa to 10.0 MPa. In the cases of the magnetic transfer, the pressure, which is applied by the pushing members 61 and 62 (i.e., the pressure applying means) to the transfer holder 301, should more preferably fall within the range of 0.05 MPa to 1.0 MPa. If the applied pressure is markedly low, there will be the risk that the close contact of each of the transfer masters 611 and 612 and the transfer slave material 15 with each other will become insufficient. If the applied pressure is markedly high, there will be the risk that the speed, with which the close contact of each of the transfer masters 611 and 612 and the transfer slave material 15 with each other occurs, will become markedly high, and the intra-plane order of the occurrence of the close contact will not be capable of being regulated accurately in the manner described above.

In this embodiment, the transfer holder 301 and the transfer apparatus 308 are constituted in the manner described above.

With this embodiment, each of the elastic materials 151 and 152 has the thickness distribution, such that the thickness becomes large continuously from the outer periphery side toward the center point side, and such that the center point side has the largest thickness. Therefore, by virtue of the thickness distribution of the elastic material 151, the close contact of the transfer master 611 and the transfer slave material 15 with each other is capable of starting from the inner periphery site on the corresponding surface of the transfer slave material 15 and successively occurring toward the outer periphery site and over the entire area of the corresponding surface of the transfer slave material 15. Also, by virtue of the thickness distribution of the elastic material 152, the close contact of the transfer slave material 15 and the transfer master 612 with each other is capable of starting from the inner periphery site on the corresponding surface of the transfer slave material 15 and successively occurring toward the outer periphery site and over the entire area of the corresponding surface of the transfer slave material 15. Further, with the transfer holder 301 employed in this embodiment, the intra-plane order of the occurrence of the close contact of each of the transfer masters 611 and 612 and the transfer slave material 15 with each other is capable of being regulated accurately. Therefore, it is possible to prevent the problems from occurring with regard to air confinement between the transfer surface 611a or 612a and the transfer accepting surface of the transfer slave material 15, and the like. Accordingly, each of the transfer masters 611 and 612 and the transfer slave material 15 are capable of being accurately brought into close contact with each other.

Furthermore, with the embodiment described above, the thickness distribution of the elastic material 151 is symmetric with respect to the center point of the transfer slave material 15 (i.e., rotationally symmetric with respect to the center axis line I). Also, the thickness distribution of the elastic material 152 is symmetric with respect to the center point of the transfer slave material 15 (i.e., rotationally symmetric with respect to the center axis line I). Therefore, the close contact of each of the transfer masters 611 and 612 and the transfer slave material 15 is capable of proceeding reliably from the inner periphery site on each of the corresponding surfaces of the transfer slave material 15 and successively occurring toward the outer periphery site. The close contact is thus capable of proceeding uniformly with respect to the peripheral direction of each of the corresponding surfaces of the transfer slave material 15, and the intra-plane order of the occurrence of the close contact is capable of being regulated accurately.

Also, in the embodiment described above, instead of the transfer masters 611 and 612 being devised in specific ways, the constitution on the side of the transfer holder 301 is devised in the specific ways. Therefore, the embodiment described above has the advantages over the conventional techniques, wherein the transfer master is merely caused to curve, in that the accurate processing of each of the elastic materials 151 and 152 for obtaining the structure for regulating the intra-plane order of the occurrence of the close contact is capable of being performed easily and at a low cost. As described above, each of the elastic materials 151 and 152 is capable of being formed accurately with the processing, such as grinding, cutting, water jet processing, or press processing. Further, the embodiment described above has the advantages over the conventional techniques in that there is no risk of the elastic material 151 or 152 becoming lifted out of the corresponding support member 41 or 42. Therefore, the entire area of each of the opposite surface 151b of the elastic material 151 and the opposite surface 152b of the elastic material 152 is capable of being accurately kept in close contact with the corresponding support member 41 or 42, and the elastic materials 151 and 152 are capable of being reliably supported by the support members 41 and 42, respectively. Accordingly, the shape of each of the elastic materials 151 and 152 for regulating the intra-plane order of the occurrence of the close contact is capable of being kept accurately even under the condition, in which a low pressure is applied to the transfer holder 301 at the initial stage of the start of the close contact of each of the transfer masters 611 and 612 and the transfer slave material 15 with each other. The accurate close contact of each of the transfer masters 611 and 612 and the transfer slave material 15 with each other is thus capable of being obtained reliably.

As described above, the elastic materials 151 and 152 are softer than the transfer masters 611 and 612 and the support members 41 and 42. Therefore, the elastic materials 151 and 152 are capable of acting as the members for regulating the intra-plane order of the occurrence of the close contact. Also, when the close contact under pressure of each of the transfer masters 611 and 612 and the transfer slave material 15 with each other is completed, the opposite surfaces of each of the elastic materials 151 and 152 take on the form of the flat surfaces or the surface shapes close to the flat surfaces. Therefore, the close contact of each of the transfer masters 611 and 612 and the transfer slave material 15 with each other is capable of occurring accurately over the entire area of each of the transfer surface 611a and the transfer surface 612a. Further, as described above, the elastic materials 151 and 152 have the shape restoring characteristics. Therefore, in cases where a next operation for the close contact under pressure is to be performed with respect to a new combination of the transfer masters 611 and 612 and the transfer slave material 15 after the most recent operation for the close contact under pressure has been finished, the elastic materials 151 and 152 are capable of again acting as the members for regulating the intra-plane order of the occurrence of the close contact.

In the embodiment described above, in cases where the transfer slave material 15 is to be taken out of the transfer holder 301 after the application of the transfer magnetic field H_{du} has been finished, the pressure applied to the transfer holder 301 is released. At this time, restoring force for the restoration to the original shape occurs with each of the elastic materials 151 and 152 and each of the transfer masters 611 and 612, which have been secured by suction to the elastic materials 151 and 152, respectively. The restoring force acts as the force for separating the transfer slave material 15 from each of the transfer surface 611a of the transfer master 611 and the transfer surface 612a of the transfer master 612. Therefore, the transfer slave material 15 is capable of being separated easily from each of the transfer surface 611a of the transfer master 611 and the transfer surface 612a of the transfer master 612 and is capable of being taken out easily from the transfer holder 301.

In the embodiment described above, wherein the transfer apparatus 308 is provided with the transfer holder 301, accurate magnetic transfer is capable of being performed. In cases where the transfer apparatus 308 in this embodiment are utilized, a magnetic recording medium having been subjected to the accurate magnetic transfer is capable of being produced reliably.

### Modifications of the Third Embodiment

The third embodiment described above may be modified in various ways.

Specifically, each of the elastic materials 151 and 152 may be replaced by an elastic material, which has the thickness distribution such that the close contact of the transfer master 611 or 612 and the transfer slave material 15 with each other is capable of starting from the specific site on the corresponding surface of the transfer slave material 15 and successively occurring over the entire area of the corresponding surface of the transfer slave material 15. In such cases, the same effects as those with the embodiment described above are capable of being obtained.

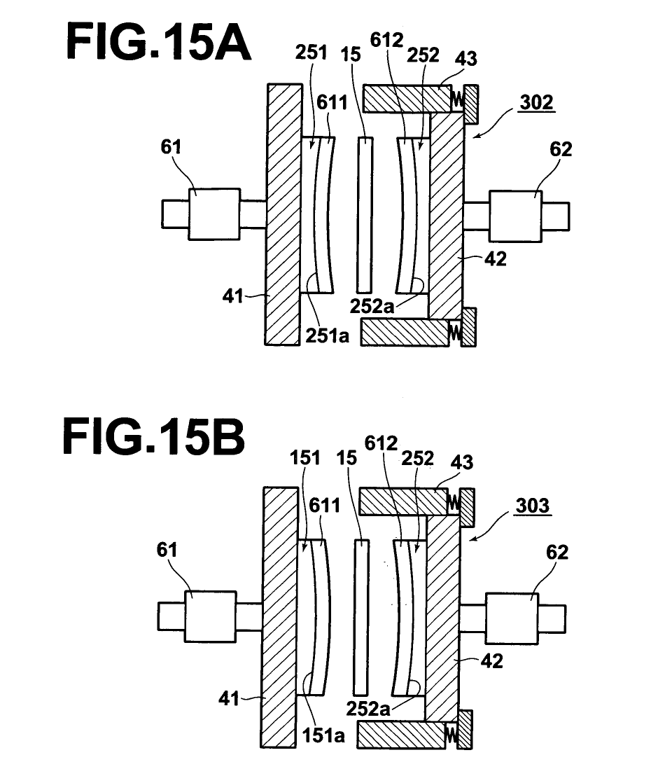

For example, FIG. 15A shows a modification, in which a transfer holder 302 is provided with an elastic material 251 and an elastic material 252. In FIG. 15A (and FIG. 15B to FIG. 18B that follow), similar elements are numbered with the same reference numerals with respect to FIG. 14A. In this modification, each of the elastic materials 251 and 252 has a thickness distribution, such that the thickness of the elastic material becomes large continuously from the center point side toward the outer periphery side, the outer periphery side being protruded to a maximum height. Also, each of a support surface 251a of the elastic material 251 and a support surface 252a of the elastic material 252 has a subspherical concave surface shape, which is symmetric with respect to the center point of the transfer slave material 15. With the constitution shown in FIG. 15A, the close contact of each of the transfer masters 611 and 612 and the transfer slave material 15 with each other starts from the outer periphery site on the transfer slave material 15 and successively occurs toward the inner periphery site.

FIG. 15B shows a modification, in which a transfer holder 303 is provided with the elastic material 151 and the elastic material 252 having different thickness distributions. In the modification shown in FIG. 15B, the elastic material 151 has the thickness distribution illustrated in FIG. 14A, and the elastic material 252 has the thickness distribution illustrated in FIG. 15A.

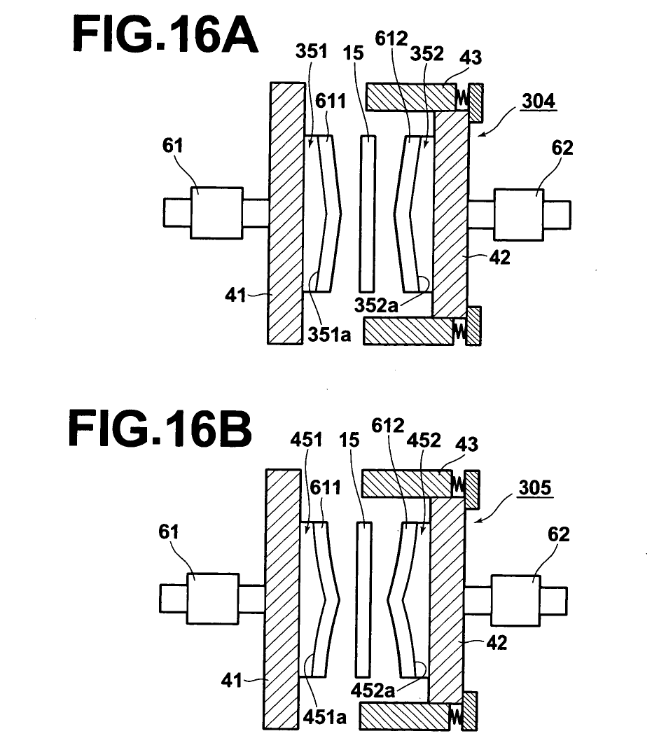

FIG. 16A shows a modification, in which a transfer holder 304 is provided with an elastic material 351 and an elastic material 352. In this modification, as in the third embodiment described above, each of the elastic materials 351 and 352 has a thickness distribution, such that the thickness of the elastic material becomes large continuously from the outer periphery side toward the center point side, the center point side being protruded to a maximum height. However, in this modification, each of a support surface 351a of the elastic material 351 and a support surface 352a of the elastic material 352 has an approximately circular cone-like convex surface shape, which is symmetric with respect to the center point of the transfer slave material 15.

FIG. 16B shows a modification, in which a transfer holder 305 is provided with an elastic material 451 and an elastic material 452. In this modification, as in the third embodiment described above, each of the elastic materials 451 and 452 has a thickness distribution, such that the thickness of the elastic material becomes large continuously from the outer periphery side toward the center point side, the center point side being protruded to a maximum height. However, in this modification, each of a support surface 451a of the elastic material 451 and a support surface 452a of the elastic material 452 has an approximately circular cone-like convex surface shape, which is symmetric with respect to the center point of the transfer slave material 15.

Also, each of the elastic materials 151 and 152 described above may be constituted such that each of the elastic materials 151 and 152 has a thickness distribution symmetric with respect to the diametral line of the transfer slave material 15, and such that each of the support surface 151a of the elastic material 151 and the support surface 152a of the elastic material 152 has a surface shape symmetric with respect to the diametral line of the transfer slave material 15. With the constitution described above, the close contact of each of the transfer masters 611 and 612 and the transfer slave material 15 is capable of proceeding symmetrically in accordance with the surface shape of the support surface, and the intra-plane order of the occurrence of the close contact is capable of being regulated accurately. Examples of the surface shapes symmetric with respect to the diametral line of the transfer slave material 15 include a paraboloidal shape, a subcylindrical surface shape, and a saddle surface shape.

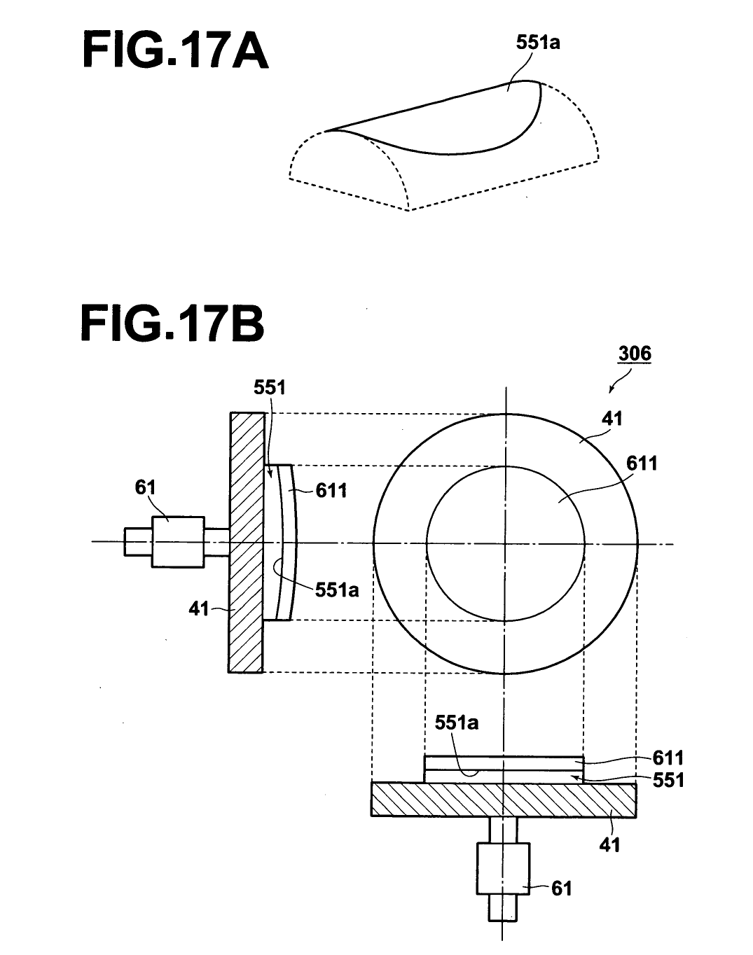

FIGS. 17A and 17B shows a modification, in which a transfer holder 306 is provided with an elastic material 551, which has a subcylindrical support surface 551a, and an elastic material 552 (not shown), which has a subcylindrical support surface 552a (not shown). FIG. 17A is a perspective view showing the subcylindrical support surface 551a of the elastic material 551. FIG. 17B is an explanatory view containing a plan view showing the transfer master 611 and the support member 41, which plan view is taken from the transfer surface side of the transfer master 611, and two side views showing the transfer master 611, the elastic material 551 having the subcylindrical support surface 551a shown in FIG. 17A, and the support member 41, which side views are taken from directions varying by an angle of 90° from each other. (In FIG. 17B, the support member 41 is illustrated by the sectional view.) The constitution on the side of the support member 42 is identical with the constitution on the side of the support member 41 illustrated in FIGS. 17A and 17B.

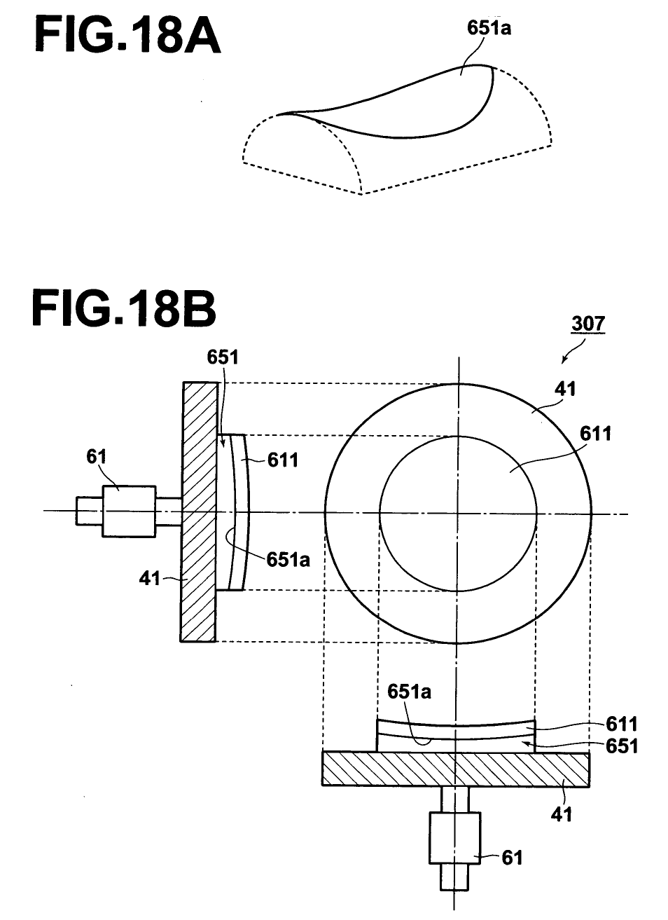

FIGS. 18A and 18B shows a modification, in which a transfer holder 307 is provided with an elastic material 651, which has a saddle surface-shaped support surface 651a, and an elastic material 652 (not shown), which has a saddle surface-shaped support surface 652a (not shown). FIG. 18A is a perspective view showing the saddle surface-shaped support surface 651a of the elastic material 651. FIG. 18B is an explanatory view containing a plan view showing the transfer master 611 and the support member 41, which plan view is taken from the transfer surface side of the transfer master 611, and two side views showing the transfer master 611, the elastic material 651 having the saddle surface-shaped support surface 651a shown in FIG. 18A, and the support member 41, which side views are taken from directions varying by an angle of 90° from each other. (In FIG. 18B, the support member 41 is illustrated by the sectional view.) The saddle surface-shaped support surface 651a of the elastic material 651 (or the saddle surface-shaped support surface 652a of the elastic material 652) has a concave-convex surface shape, such that two sites on the outer periphery, which sites lie on an identical diametral line, are protruded to a maximum height, and sites deviated by an angle of 90° from the sites protruded to the maximum height are depressed to a minimum height. With the constitution described above, the close contact of each of the transfer masters 611 and 612 and the transfer slave material 15 with each other starts from the two sites on the outer periphery of each of the support surfaces 651a and 652a, which sites lie on the identical diametral line and are protruded to the maximum height, and successively proceeds from the sides having a high surface height toward the sides having a low surface height.

Each of the elastic materials 151 and 152 should preferably be constituted such that the thickness of the elastic material alters continuously from the thick side to the thin side. Alternatively, each of the elastic materials 151 and 152 may be constituted such that the thickness of the elastic material alters by stages from the thick side to the thin side.

Also, either one of the elastic materials 151 and 152 described above may be constituted as a flat elastic material having no thickness distribution. In cases where at least either one of the elastic materials 151 and 152 described above has the thickness distribution, the close contact of at least either one of the transfer masters 611 and 612 and the transfer slave material 15 with each other is capable of starting from the specific site on the corresponding surface of the transfer slave material 15 and successively occurring over the entire area of the corresponding surface of the transfer slave material 15. In such cases, the close contact is capable of being achieved more appropriately than with conventional techniques, wherein a transfer holder is provided with only flat elastic materials having no thickness distribution.

In the embodiment described above, each of the elastic materials 151 and 152 has the thickness distribution in the state, in which the pair of the support members 41 and 42 take the positions spaced away from each other. Alternatively, in lieu of each of the elastic materials 151 and 152 being constituted to have the thickness distribution, each of the elastic materials 151 and 152 may be constituted to have a hole forming density distribution of the suction holes.

In cases where, in lieu of each of the elastic materials 151 and 152 being constituted to have the thickness distribution, each of the elastic materials 151 and 152 is constituted to have the hole forming density distribution of the suction holes, the thickness distribution is capable of being caused to occur with each of the elastic materials 151 and 152 in the state, in which the transfer master 611 is secured by suction via the elastic material 151 to the support member 41, and in which the transfer master 612 is secured by suction via the elastic material 152 to the support member 42. As a result, the same effects as those with the third embodiment described above are capable of being obtained. Specifically, a region of each of the elastic materials 151 and 152, which region has the suction holes formed at a high hole forming density, is apt to be subjected to suction stronger than-the suction at a region of each of the elastic materials 151 and 152, which region has the suction holes formed at a low hole forming density. Therefore, the region of each of the elastic materials 151 and 152, which region has the suction holes formed at the high hole forming density, is apt to become thinner than the region of each of the elastic materials 151 and 152, which region has the suction holes formed at the low hole forming density. As a result, as described above, the thickness distribution is capable of being caused to occur with each of the elastic materials 151 and 152. Accordingly, in cases where the support member 41 is provided with the suction mechanism, the elastic material 151 may be constituted to have the suction holes formed with the hole forming density distribution adapted for imparting the thickness distribution to the elastic material 151 in the state, in which the transfer master 611 has been secured by suction to the support member 41 with the elastic material 151 intervening between the transfer master 611 and the support member 41, the thickness distribution being such that the close contact of the transfer master 611 and the transfer slave material 15 with each other starts from the specific site on the corresponding surface of the transfer slave material 15 and successively occurs over the entire area of the corresponding surface of the transfer slave material 15. Also, in cases where the support member 42 is provided with the suction mechanism, the elastic material 152 may be constituted to have the suction holes formed with the hole forming density distribution adapted for imparting the thickness distribution to the elastic material 152 in the state, in which the transfer master 612 has been secured by suction to the support member 42 with the elastic material 152 intervening between the transfer master 612 and the support member 42, the thickness distribution being such that the close contact of the transfer master 612 and the transfer slave material 15 with each other starts from the specific site on the corresponding surface of the transfer slave material 15 and successively occurs over the entire area of the corresponding surface of the transfer slave material 15. By way of example, in order for the hole forming density of the suction holes to be distributed, the number of the suction holes may be distributed. Alternatively, the hole diameters of the suction holes may be distributed.

In cases where each of the elastic materials 151 and 152 has holes other than the suction holes, the hole forming density of all of the holes containing the suction holes may be distributed. The region of each of the elastic materials 151 and 152, which region has the holes other than the suction holes, has a comparatively reduced modulus of elasticity and is apt to become thin at the time of the suction. Therefore, in such cases, the same effects as those described above are capable of being obtained.

Both of the pair of the support members 41 and 42 should preferably be provided with the elastic materials 151 and 152, respectively. Alternatively, at least either one of the support members 41 and 42 may be provided with the elastic material.

The technique for securing each of the transfer masters 611 and 612 to the corresponding one of the support members 41 and 42 is not limited to the securing by suction. For example, a technique for securing by use of an adhesive agent, magnetic force, or the like, may be employed.

In the third embodiment described above, the surface information carried by the transfer master 611 is transferred to one of the opposite surfaces of the transfer slave material 15, and the surface information carried by the transfer master 612 is transferred to the other surface of the transfer slave material 15. The transfer apparatus in accordance with the present invention may also be constituted for a transfer operation for transferring the surface information to only one surface of the transfer slave material 15. With the transfer operation for transferring the surface information to only one surface of the transfer slave material 15, firstly, the pair of the support members 41 and 42 are located at the positions spaced away from each other, and the one transfer master 611 and the transfer slave material 15 are located so as to stand facing each other between the pair of the support members 41 and 42. Thereafter, the pair of the support members 41 and 42 are caused to come close to each other, and the transfer master 611 and the transfer slave material 15 are thus brought into close contact with each other under pressure. In this manner, the transfer information carried by the transfer master 611 is transferred to the one surface of the transfer slave material 15.

In the cases of the transfer operation for transferring the surface information to only one surface of the transfer slave material 15, ordinarily, the one transfer master 611 is secured to the one support member 41, the transfer slave material 15 is supplied to the transfer surface 611a of the transfer master 611 in this state, and the transfer master 611 and the transfer slave material 15 are brought into close contact with each other. Alternatively, the transfer slave material 15 may be secured to the one support member 141, the one transfer master 611 maybe supplied to the surface of the transfer slave material 15 in this state, and the transfer master 611 and the transfer slave material 15 may be brought into close contact with each other. Specifically, in the cases of the transfer operation for transferring the surface information to only one surface of the transfer slave material 15, the transfer master 611 or the transfer slave material 15 is secured to the support member 41 with the elastic material 51 intervening between the transfer master 611 or the transfer slave material 15 and the support member 41.

In the cases of the transfer operation for transferring the surface information to only one surface of the transfer slave material 15, the elastic material 51 described above may be constituted to have the thickness distribution, such that the close contact of the one transfer master 611 and the transfer slave material 15 with each other starts from the specific site on the corresponding surface of the transfer slave material 15 and successively occurs over the entire area of the corresponding surface of the transfer slave material 15. Also, as in the cases of the transfer to the opposite surfaces of the transfer slave material 15, in cases where the support member 41 is provided with the suction mechanism, the elastic material 151 may be constituted to have the suction holes and other holes formed with the hole forming density distribution adapted for imparting the thickness distribution to the elastic material 151 in the state, in which the transfer master 611 or the transfer slave material 15 has been secured by suction to the support member 41 with the elastic material 151 intervening between the transfer master 611 or the transfer slave material 15 and the support member 41, the thickness distribution being such that the close contact of the transfer master 611 and the transfer slave material 15 with each other starts from the specific site on the corresponding surface of the transfer slave material 15 and successively occurs over the entire area of the corresponding surface of the transfer slave material 15.

The transfer holder and the transfer apparatus employed in the third embodiment in accordance with the present invention are appropriate particularly for magnetic transfer, in which strict position adjustments are required. The transfer holder and the transfer apparatus employed in the third embodiment in accordance with the present invention are applicable also to various kinds of transfer techniques, in which the transfer master and the transfer slave material are brought into close contact with each other, and information, such as magnetic information or shape information, is transferred from the transfer master to the transfer slave material.

### Industrial Applicability

The present invention is applicable to various transfer techniques, such as magnetic transfer techniques, nano-imprinting techniques, and patterned media techniques, wherein a transfer master, which carries a predetermined recess-protrusion pattern on a surface, is brought into close contact with a transfer slave material, and wherein information, such as magnetic information, which corresponds to the recess-protrusion pattern carried on the surface of the transfer master, or a recess-protrusion pattern shape, which corresponds to the recess-protrusion pattern carried on the surface of the transfer master, is thereby transferred to the transfer slave material.

What is claimed is:

1. A transfer master, which has a transfer surface carrying transfer information, the transfer master being adapted for use in a transfer operation for bringing the transfer surface of the transfer master and a transfer slave material into close contact with each other, and thereby transferring the transfer information from the transfer surface of the transfer master to the transfer slave material,
wherein the transfer master has a thickness distribution, such that the close contact of the transfer surface of the transfer master and the transfer slave material with each other starts from a specific site on the transfer surface of the transfer master and successively occurs over the entire area of the transfer surface of the transfer master.

2. A transfer master as defined in claim 1 wherein each of the transfer master and the transfer slave material has a circular disk-like shape, and the thickness distribution of the transfer master is symmetric with respect to a center point of the transfer master or a diametral line of the transfer master.

3. A transfer master as defined in claim 1 wherein a surface of the transfer master, which surface is opposite to the transfer surface of the transfer master, is a flat surface,
the transfer surface of the transfer master has a surface height distribution corresponding to the thickness distribution of the transfer master, and
a maximum difference in surface height of a region of the transfer surface, which region carries the transfer information, alters such that the maximum difference in surface height at the time of an end of the close contact becomes smaller than the maximum difference in surface height at the time before the close contact starts.

4. A transfer master as defined in claim 1 wherein the transfer master is adapted for magnetic transfer.

5. A transfer holder, comprising a pair of support members, which are capable of taking positions close to each other and positions spaced away from each other, the pair of the support members being adapted to support a transfer master as defined in claim 1 and a transfer slave material between the pair of the support members.

6. A transfer holder, comprising a pair of support members, which are capable of taking positions close to each other and positions spaced away from each other, the pair of the support members being adapted to support a pair of transfer masters, each of which carries surface information, and a transfer slave material between the pair of the support members, such that the surface information carried by one of the transfer masters and the surface information carried by the other transfer master are transferred to opposite surfaces of the transfer slave material,
the transfer holder being adapted for use in a transfer operation for locating the pair of the transfer masters and the transfer slave material between the pair of the support members in a state, in which the pair of the support members take the positions spaced away from each other, such that the pair of the transfer masters stand facing the transfer slave material from the opposite surface sides of the transfer slave material, causing the pair of the support members to come close to each other, and thereby bringing each of the pair of the transfer masters and the transfer slave material into close contact with each other under pressure,
wherein the transfer holder has a constitution such that the close contact of at least either one of the transfer masters and the transfer slave material with each other starts from a specific site on the corresponding surface of the transfer slave material and successively occurs over the entire area of the corresponding surface of the transfer slave material.

7. A transfer holder, comprising a pair of support members, which are capable of taking positions close to each other and positions spaced away from each other, the pair of the support members being adapted to support a transfer master, which carries surface information, and a transfer slave material between the pair of the support members, such that the surface information carried by the transfer master is transferred to one surface of the transfer slave material, the transfer holder being adapted for use in a transfer operation for locating the transfer master and the transfer slave material between the pair of the support members in a state, in which the pair of the support members take the positions spaced away from each other, such that the transfer master and the one surface of the transfer slave material stand facing each other, causing the pair of the support members to come close to each other, and thereby bringing the transfer master and the transfer slave material into close contact with each other under pressure,
wherein the transfer holder has a constitution such that the close contact of the transfer master and the transfer slave material with each other starts from a specific site on the one surface of the transfer slave material and successively occurs over the entire area of the one surface of the transfer slave material.

8. A transfer holder as defined in claim 6 wherein a support surface of at least either one of the pair of the support members, which support surface supports the corresponding transfer master and the transfer slave material, has a surface height distribution such that a site on the support surface corresponding to the specific site on the surface of the transfer slave material, from which specific site the close contact starts, is protruded to a maximum height.

9. A transfer holder as defined in claim 7 wherein a support surface of at least either one of the pair of the support members, which support surface supports the transfer master and the transfer slave material, has a surface height distribution such that a site on the support surface corresponding to the specific site on the surface of the transfer slave material, from which specific site the close contact starts, is protruded to a maximum height.

10. A transfer holder as defined in claim 8 wherein each of the transfer master and the transfer slave material has a circular disk-like shape, and the support surface has a surface shape, which is symmetric with respect to a center point of the transfer slave material or a diametral line of the transfer slave material.

11. A transfer holder as defined in claim 9 wherein each of the transfer master and the transfer slave material has a circular disk-like shape, and the support surface has a surface shape, which is symmetric with respect to a center point of the transfer slave material or a diametral line of the transfer slave material.

12. A transfer holder as defined in claim 8 wherein a maximum difference in surface height of a region of the support surface, which region corresponds to an information transfer accepting region of the transfer slave material, alters such that the maximum difference in surface height at the time of an end of the close contact becomes smaller than the maximum difference in surface height at the time before the close contact starts.

13. A transfer holder as defined in claim 9 wherein a maximum difference in surface height of a region of the support surface, which region corresponds to an information transfer accepting region of the transfer slave material, alters such that the maximum difference in surface height at the time of an end of the close contact becomes smaller than the maximum difference in surface height at the time before the close contact starts.

14. A transfer holder as defined in claim 6 wherein at least either one of the pair of the support members is provided with an elastic material, the elastic material being located on a support surface of the at least either one of the pair of the support members, which support surface supports the corresponding transfer master and the transfer slave material, and
the elastic material has a thickness distribution, such that the close contact of the transfer master and the transfer slave material with each other starts from the specific site on the corresponding surface of the transfer slave material and successively occurs over the entire area of the corresponding surface of the transfer slave material.

15. A transfer holder as defined in claim 6 wherein at least either one of the pair of the support members is provided with an elastic material, which has a plurality of holes containing suction holes, the elastic material being located on a support surface of the at least either one of the pair of the support members, which support surface supports the corresponding transfer master and the transfer slave material, and
the elastic material has the plurality of the holes having been formed with a hole forming density distribution adapted for imparting a thickness distribution to the elastic material in a state, in which the corresponding transfer master has been secured by suction to the at least either one of the pair of the support members with the elastic material intervening between the corresponding transfer master and the at least either one of the pair of the support members,
the thickness distribution being such that the close contact of the transfer master and the transfer slave material with each other starts from the specific site on the corresponding surface of the transfer slave material and successively occurs over the entire area of the corresponding surface of the transfer slave material.

16. A transfer holder as defined in claim 7 wherein at least either one of the pair of the support members is provided with an elastic material, the elastic material being located on a support surface of the at least either one of the pair of the support members, which support surface supports the transfer master and the transfer slave material, and
the elastic material has a thickness distribution, such that the close contact of the transfer master and the transfer slave material with each other starts from the specific site on the corresponding surface of the transfer slave material and successively occurs over the entire area of the corresponding surface of the transfer slave material.

17. A transfer holder as defined in claim 7 wherein at least either one of the pair of the support members is provided with an elastic material, which has a plurality of holes containing suction holes, the elastic material being located on a support surface of the at least either one of the pair of the support members, which support surface supports the transfer master and the transfer slave material, and
the elastic material has the plurality of the holes having been formed with a hole forming density distribution adapted for imparting a thickness distribution to the elastic material in a state, in which the transfer master has been secured by suction to the at least either one of the pair of the support members with the elastic material intervening between the transfer master and the at least either one of the pair of the support members,
the thickness distribution being such that the close contact of the transfer master and the transfer slave material with each other starts from the specific site on the corresponding surface of the transfer slave material and successively occurs over the entire area of the corresponding surface of the transfer slave material.

18. A transfer holder as defined in claim 14 wherein each of the transfer master and the transfer slave material has a circular disk-like shape, and the thickness distribution of the elastic material is symmetric with respect to a center point of the transfer slave material or a diametral line of the transfer slave material.

19. A transfer holder as defined in claim 15 wherein each of the transfer master and the transfer slave material has a circular disk-like shape, and the thickness distribution imparted to the elastic material is symmetric with respect to a center point of the transfer slave material or a diametral line of the transfer slave material.

20. A transfer holder as defined in claim 16 wherein each of the transfer master and the transfer slave material has a circular disk-like shape, and the thickness distribution of the elastic material is symmetric with respect to a center point of the transfer slave material or a diametral line of the transfer slave material.

21. A transfer holder as defined in claim 17 wherein each of the transfer master and the transfer slave material has a circular disk-like shape, and the thickness distribution imparted to the elastic material is symmetric with respect to a center point of the transfer slave material or a diametral line of the transfer slave material.

22. A transfer holder as defined in claim 6 wherein the transfer holder is adapted for magnetic transfer.

23. A transfer holder as defined in claim 7 wherein the transfer holder is adapted for magnetic transfer.

24. A transfer apparatus, comprising a transfer holder as defined in claim 5, and pressure applying means for applying a pressure to the transfer holder, the pressure, which is applied by the pressure applying means to the transfer holder, falling within the range of 0.05 MPa to 10.0 MPa.

25. A transfer apparatus, comprising a transfer holder as defined in claim 6, and pressure applying means for applying a pressure to the transfer holder, the pressure, which is applied by the pressure applying means to the transfer holder, falling within the range of 0.05 MPa to 10.0 MPa.

26. A transfer apparatus, comprising a transfer holder as defined in claim 7, and pressure applying means for applying a pressure to the transfer holder, the pressure, which is applied by the pressure applying means to the transfer holder, falling within the range of 0.05 MPa to 10.0 MPa.

27. A magnetic recording medium, which is produced with a magnetic transfer operation for bringing a transfer master as defined in claim 4 and a transfer slave material into close contact with each other, and magnetically transferring the transfer information from the transfer master to a transfer accepting surface of the transfer slave material.

28. A magnetic recording medium, which is produced with a magnetic transfer operation performed by use of a transfer holder as defined in claim 22.

29. A magnetic recording medium, which is produced with a magnetic transfer operation performed by use of a transfer holder as defined in claim 23.
